(19) United States
(12) Patent Application Publication
(10) Pub. No.: US 2025/0310635 A1
(43) Pub. Date: Oct. 2, 2025

(54) DATA PROCESSING METHOD, DATA PROCESSING SYSTEM, ELECTRONIC DEVICE AND STORAGE MEDIUM

(71) Applicant: SHENZHEN TRANSSION HOLDINGS CO., LTD., Guangdong (CN)

(72) Inventors: Jianliang LAN, Guangdong (CN); Hongwei WANG, Guangdong (CN); Guoqiang SHANG, Guangdong (CN); Longan XIAO, Guangdong (CN); Linxi KE, Guangdong (CN)

(73) Assignee: SHENZHEN TRANSSION HOLDINGS CO., LTD., Guangdong (CN)

(21) Appl. No.: 18/617,588

(22) Filed: Mar. 26, 2024

Related U.S. Application Data
(63) Continuation of application No. PCT/CN2021/122436, filed on Sep. 30, 2021.

(51) Int. Cl. H04N 23/60

(52) U.S. Cl. CPC H04N 23/64

(57) ABSTRACT

Provided are a data processing method, a data processing system, an electronic device, and a storage medium. The data processing method is applied to the electronic device, and includes the following steps: acquiring, through an auxiliary unit, a target image request to determine or generate an image processing instruction (S10); processing, according to the image processing instruction, image data through an image processing unit to obtain a target image (S20). In the method, the target image request is acquired through the auxiliary unit, the image processing instruction is determined or generated according to the target image request; the image data is processed according to the image processing instruction and through the image processing unit, to obtain the target image. A new computational photography system architecture including the auxiliary unit and the image processing unit is provided, capable of achieving computational photography image processing.

### CROSS-REFERENCE TO RELATED APPLICATIONS

The present application is a continuation of International Application No. PCT/CN2021/122436, filed on Sep. 30, 2021, the disclosure of which is hereby incorporated by reference in its entirety.

### TECHNICAL FIELD

Embodiments of the present application relate to the field of computational photography technology and, in particular, to a data processing method, a data processing system, an electronic device, and a storage medium.

### BACKGROUND

The current “computational photography system” is a data processing system carrying computational photography (CP) technology. In other words, the data processing system is formed by adding computational photography-related application software and algorithms to a computer system.

From a perspective of a hierarchical relationship in a data processing system within the industry, a hierarchical structure may be used for description, usually including an application layer, a middle layer, a kernel layer, and a hardware layer. Optionally, the application layer includes computational photography application software and camera framework; the middle layer includes a camera hardware abstract layer (Camera HAL); the kernel layer includes an operating system kernel and a driver; and the hardware layer includes hardware related to the computational photography. The algorithm modules related to the computational photography are integrated in the Camera HAL of the middle layer and/or in the application layer.

In the process of conceptualizing and implementing the present application, the inventors found at least the following problems: the algorithm modules related to the computational photography are independently developed by respective developers, and the algorithm modules cannot be reused between applications, which makes it impossible to share algorithm functions, resulting in long development time and low development efficiency of the algorithm modules related to the computational photography.

The foregoing description is intended to provide general background information and does not necessarily constitute a prior art.

### SUMMARY

Embodiments of the present application provide a data processing method, a data processing system, an electronic device and a storage medium to solve a problem of long development time and low development efficiency of an algorithm module related to computational photography.

In one aspect, the present application provides a data processing method, including the following steps:
step S10: acquiring, through an auxiliary unit, a target image request to determine or generate an image processing instruction;
step S11: processing, according to the image processing instruction, image data through an image processing unit to obtain a target image.

In an embodiment, the step S10 includes at least one of the following:
issuing, through the auxiliary unit, an imaging control instruction to a camera service, and issuing the image processing instruction to the image processing unit;
issuing, through the auxiliary unit, an image acquiring instruction to an image supply service, and issuing the image processing instruction to the image processing unit.

In an embodiment, the step S10 includes:
parsing, through the auxiliary unit, the target image request to determine at least one of imaging control requirement information, image processing requirement information and image acquiring requirement information corresponding to the target image.

In an embodiment, the step S10 includes at least one of the following:
determining or generating the imaging control instruction according to the imaging control requirement information;
determining or generating the image processing instruction according to the image processing requirement information;
determining or generating the image acquiring instruction according to the image acquiring requirement information.

In an embodiment, the step S11 includes:
performing, according to the image processing instruction and/or image metadata of the image data, image processing on the image data through the image processing unit to obtain the target image.

In an embodiment, before the step S11, the method further includes:
acquiring, according to the imaging control instruction, the image data and/or the image metadata of the image data through a camera service;
and/or, acquiring, according to the image acquiring instruction, the image data and/or the image metadata of the image data through an image supply service.

In an embodiment, after the acquiring, according to the imaging control instruction, the image data and/or the image metadata of the image data, the method further includes:
transmitting the image data and/or the image metadata to the image processing unit; or,
transmitting the image data and/or the image metadata to a basic processing unit which then transmits processed image data and/or image metadata to the image processing unit.

In an embodiment, the image processing unit includes at least one service management module and/or at least one processing service;
the performing the image processing on the image data to obtain the target image includes:
acquiring, according to the image processing instruction, the processing service corresponding to the image processing instruction through the service management module;
performing, according to the image processing instruction and/or the image metadata, the image processing on the image data through the processing service to obtain the target image.

In an embodiment, the auxiliary unit, the service management module and the processing service perform separate independent running.

In an embodiment, the target image request is sent by an application; and/or,
after the obtaining the target image, the method further includes: outputting the target image to enable the application to acquire the target image.

In another aspect, the present application further provides a data processing method, including the following steps:
step S20: determining or generating, according to a preset module and image processing requirement information, an image processing instruction;
step S21: performing, according to the image processing instruction, image processing on image data to obtain a target image.

In an embodiment, before the step S20, the method further includes:
determining or generating, in response to a request for acquiring the target image, at least one of an imaging control instruction, an image processing instruction and an image acquiring instruction corresponding to the target image;
acquiring, according to the imaging control instruction and/or the image acquiring instruction, the image data and/or image metadata of the image data.

In an embodiment, the determining or the generating, in response to the request for acquiring the target image, the at least one of the imaging control instruction, the image processing instruction and the image acquiring instruction corresponding to the target image includes:
acquiring, through an auxiliary unit, the request for the target image;
parsing, through the auxiliary unit, the request to determine at least one of imaging control requirement information, image processing requirement information and image acquiring requirement information;
if the imaging control requirement information is obtained through the parsing, determining or generating the imaging control instruction according to the imaging control requirement information;
if the image processing requirement information is obtained through the parsing, determining or generating the image processing instruction according to image processing requirement information;
if the image acquiring requirement information is obtained through the parsing, determining or generating the image acquiring instruction according to the image acquiring requirement information.

In an embodiment, the acquiring, according to the imaging control instruction and/or the image acquiring instruction, the image data and/or the image metadata of the image data includes:
sending, through the auxiliary unit, the imaging control instruction to a camera service, and acquiring, according to the imaging control instruction, captured image data and/or image metadata of the image data through the camera service;
and/or,
sending, through the auxiliary unit, the image acquiring instruction to an image supply service, and acquiring, according to the image acquiring instruction, the image data and/or the image metadata of the image data through the image supply service.

In an embodiment, the step S20 includes:
using, according to the image processing requirement information, the preset module through the auxiliary unit to determine or generate the image processing instruction.

In an embodiment, the step S20 includes:
determining, according to the image processing requirement information and algorithm description metadata of an algorithm module in an algorithm library file provided by the preset module, at least one algorithm module that matches the image processing requirement information;
assembling, according to the image processing requirement information, the at least one algorithm module to determine or generate the image processing instruction.

In an embodiment, the determining, according to the image processing requirement information and the algorithm description metadata of the algorithm module in the algorithm library file provided by the preset module, the at least one algorithm module that matches the image processing requirement information includes:
according to the image processing requirement information, if it is determined that the at least one algorithm module is missing from the preset module, acquiring, from a server, the missed at least one algorithm module.

In an embodiment, the step S20 further includes:
sending, through the auxiliary unit, the image processing instruction to a service management module.

In an embodiment, the step S21 includes:
acquiring, through the service management module, a processing service corresponding to the image processing instruction;
performing, according to the image processing instruction and/or the image metadata, the image processing on the image data through the processing service to obtain the target image.

In an embodiment, the acquiring, through the service management module, the processing service corresponding to the image processing instruction includes at least one of the following:
through the service management module, according to the image processing instruction, if it is determined that there is a processing service that matches the image processing instruction and is in an idle state, using the processing service that matches the image processing instruction and is in the idle state as a processing service corresponding to the image processing instruction;
through the service management module, according to the image processing instruction, if it is determined that there is a processing service that matches the image processing instruction and the processing service that matches the image processing instruction is in an occupied state, creating the processing service corresponding to the image processing instruction, or, until the processing service that matches the image processing instruction enters an idle state, using the processing service that matches the image processing instruction and is in the idle state as the processing service corresponding to the image processing instruction;
through the service management module, according to the image processing instruction, if it is determined that there is no processing service that matches the image processing instruction, creating, according to the image processing instruction, a processing service corresponding to the image processing instruction.

In an embodiment, after the using the processing service that matches the image processing instruction and is in the idle state as the processing service corresponding to the image processing instruction, the method further includes:
if the processing service corresponding to the image processing instruction is not stored in a memory, loading the processing service corresponding to the image processing instruction into the memory, and starting the processing service corresponding to the image processing instruction.

In an embodiment, the method further includes at least one of the following:
after the acquiring, according to the imaging control instruction, the captured image data and/or the image metadata of the image data through the camera service, the method further includes: transmitting, through the camera service, the image data and/or the image metadata to the processing service;
after the acquiring, according to the image acquiring instruction, the image data and/or the image metadata of the image data through the image supply service, the method further includes: transmitting, through the image supply service, the image data and/or the image metadata to the processing service.

In an embodiment, the method further includes at least one of the following:
the performing, according to the image processing instruction and/or the image metadata, the image processing on the image data through the processing service to obtain the target image includes: executing, according to the image processing instruction and/or the image metadata, a processing pipeline corresponding to the image processing instruction through the processing service to implement the image processing on the image data to obtain the target image; after the performing, according to the image processing instruction and/or the image metadata, the image processing on the image data through the processing service to obtain the target image, the method further includes: feeding back, through the processing service, the target image to the auxiliary unit, outputting, through the auxiliary unit, the target image.

In an embodiment, after the feeding back, through the processing service, the target image to the auxiliary unit, the method further includes:
pausing and saving, or destroying, according to the image processing instruction, the processing service through the service management module.

In an embodiment, the method includes at least one of the following:
the transmitting, through the camera service, the image data and/or the image metadata to the processing service includes: storing, through the camera service, the image data and/or the image metadata in a shared memory, and acquiring, through the processing service, the image data and/or the image metadata from the shared memory;
the transmitting, through the image supply service, the image data and/or the image metadata to the processing service includes: storing, through the image supply service, the image data and/or the image metadata in the shared memory, and acquiring, through the processing service, the image data and/or the image metadata from the shared memory.

In an embodiment, the feeding back, through the processing service, the target image to the auxiliary unit includes:
storing, through the processing service, the target image in a shared memory;
acquiring, from the shared memory, the target image through the auxiliary unit.

In an embodiment, the auxiliary unit acquires the request through an application programming interface, the application programming interface is used to implement a corresponding computational photography image processing function by calling at least one algorithm module in an algorithm library file.

In an embodiment, the preset module is provided by a data processing system, and/or, the preset module includes at least one algorithm library file and algorithm description metadata corresponding to the at least one algorithm library file.

In an embodiment, the method further includes at least one of the following:
in response to an algorithm function query request, acquiring and displaying the at least one algorithm library file, and/or at least one set of algorithm description metadata corresponding to the algorithm library file;
in response to an algorithm library file new adding request, adding a newly added algorithm library file and algorithm description metadata corresponding to the algorithm library file to an algorithm library;
in response to a deleting request for any algorithm library file, deleting, from the algorithm library, the algorithm library file and algorithm description metadata corresponding to the algorithm library file;
in response to a modification operation on any algorithm library file, recompiling a modified algorithm library file;
in response to a modification request for algorithm description metadata of any algorithm module in any algorithm library file, updating the algorithm description metadata of the algorithm module in the algorithm library.

In an embodiment, before the performing, according to the image processing instruction, the image processing on the image data to obtain the target image, the method further includes:
loading, according to the image processing instruction, the algorithm library file into a memory.

In another aspect, the present application further provides a data processing system, including: an auxiliary unit and an image processing unit;
where the image processing unit includes: a first processing module and a second processing module;
the first processing module is configured to control, according to an image processing instruction, the second processing module;
the second processing module is configured to perform, according to the image processing instruction, image processing on image data to obtain a target image.

In an embodiment, the system further includes at least one of the following:
a data transmission performed between any two of the auxiliary unit, the first processing module and the second processing module;
separate independent running among the auxiliary unit, the first processing module and the second processing module.

In an embodiment, the data processing system further includes an inter-process communication driver, where each of the auxiliary unit, the first processing module and the second processing module contains an inter-process communication interface,
the inter-process communication interface is used between corresponding processes of any two of the auxiliary unit, the first processing module and the second processing module, and the inter-process communication driver is utilized to implement an inter-process communication.

In an embodiment, the auxiliary unit further includes a program library for implementing an application programming interface and the inter-process communication interface.

In an embodiment, the auxiliary unit further includes: an application programming interface, where an application issues a request for acquiring the target image to the auxiliary unit by calling the application programming interface.

In an embodiment, the data processing system further includes: at least one algorithm library file, and algorithm description metadata corresponding to each algorithm library file.

In an embodiment, the auxiliary unit is configured to:
parse a request for acquiring the target image issued by an application, and determine at least one of imaging control requirement information, image processing requirement information, and image acquiring requirement information corresponding to the target image;
determine or generate the image processing instruction according to the image processing requirement information, and issue the image processing instruction to the image processing unit.

In an embodiment, the auxiliary unit is specifically configured to:
determine, according to the image processing requirement information and algorithm description metadata of an algorithm module, at least one algorithm module that matches the image processing requirement information;
assemble, according to the image processing requirement information, the at least one algorithm module to determine or generate the image processing instruction.

In an embodiment, the auxiliary unit is further configured to:
determine or generate an imaging control instruction according to the imaging control requirement information, and issue the imaging control instruction to a camera service;
and/or,
determine or generate an image acquiring instruction according to the image acquiring requirement information, and issue the image acquiring instruction to an image supply service.

In an embodiment, the first processing module is configured to at least one of the following:
according to the image processing instruction, if it is determined that there is a second processing module that matches the image processing instruction and is in an idle state, use the second processing module that matches the image processing instruction and is in the idle state as a second processing module corresponding to the image processing instruction;
according to the image processing instruction, if it is determined that there is a second processing module that matches the image processing instruction and the second processing module that matches the image processing instruction is in an occupied state, create a second processing module corresponding to the image processing instruction, or until the second processing module that matches the image processing instruction enters an idle state, use the second processing module that matches the image processing instruction and is in the idle state as a second processing module corresponding to the image processing instruction;
according to the image processing instruction, if it is determined that there is no second processing module that matches the image processing instruction, create, according to the image processing instruction, a second processing module corresponding to the image processing instruction;
after using the second processing module that matches the image processing instruction and is in the idle state as the second processing module corresponding to the image processing instruction, if the second processing module corresponding to the image processing instruction is not stored in a memory, load the second processing module corresponding to the image processing instruction into the memory and start the second processing module corresponding to the image processing instruction.

In an embodiment, the first processing module is further configured to:
after returning the target image to the auxiliary unit, pause and save, or destroy, according to the image processing instruction, the second processing module.

In an embodiment, the second processing module is configured to:
execute, through at least one thread, a processing pipeline corresponding to the image processing instruction to implement the image processing on the image data to obtain the target image.

In an embodiment, the processing pipeline corresponding to the image processing instruction includes at least one sub-pipeline, where the at least one sub-pipeline runs within one thread, or the at least one sub-pipeline is run in parallel by at least two threads.

In another aspect, the present application further provides an electronic device, including: a processor and a memory;
where the memory stores computer execution instructions and related data;
when the computer execution instructions are executed by the processor, the method described above in any item is implemented.

In another aspect, the present application further provides a computer readable storage medium, having computer execution instructions stored therein, where when the computer execution instructions are executed by a processor, the method described above in any item is implemented.

In another aspect, the present application further provides a computer program product, including computer programs, where when the computer programs are executed by a processor, the method described above in any item is implemented.

A data processing method, a data processing system, an electronic device and a storage medium provided in the present application can achieve plugin management of an algorithm module, achieve reusing of the algorithm module, simplify a development process, and improve the development efficiency of the algorithm module.

### BRIEF DESCRIPTION OF DRAWINGS

The accompanying drawings here are incorporated into the specification and constitute a part of the specification, showing embodiments that comply with the present application, and are used to explain the principle of the present application together with the specification. In order to illustrate the technical solutions of the embodiments of the present application more clearly, the following will briefly introduce the accompanying drawings used in the description of the embodiments. Obviously, for those of ordinary skill in the art, other drawings can be obtained from these drawings without paying creative labor.

FIG. 1 is an example of a hierarchical structure of a data processing system provided by an embodiment of the present application.

FIG. 2 is an implementation of a data processing system provided by an embodiment of the present application.

FIG. 3 is an example of another hierarchical structure of a data processing system provided by an embodiment of the present application.

FIG. 4 is another implementation of a data processing system provided by an embodiment of the present application.

FIG. 5 is a schematic diagram of a new data processing system architecture provided by a first embodiment of the present application.

FIG. 6 is a schematic diagram of a hierarchical structure of a new data processing system provided by the present application.

FIG. 7 is a flowchart of a data processing method provided by a second embodiment of the present application.

FIG. 8 is a flowchart of a data processing method provided by a third embodiment of the present application.

FIG. 9 is a flowchart of a data processing method provided by a fourth embodiment of the present application.

FIG. 10 is a flowchart of a data processing method provided by a fifth embodiment of the present application.

FIG. 11 is a schematic diagram of a control instruction pipeline and an image processing pipeline of a data processing system provided by a sixth embodiment of the present application.

FIG. 12 is a flowchart of a data processing method provided by a sixth embodiment of the present application.

FIG. 13 is a framework diagram of a workflow of a CPS Manager provided by a sixth embodiment of the present application.

FIG. 14 is a framework diagram of a workflow of a CP Service provided by a sixth embodiment of the present application.

FIG. 15 is a framework diagram of an inter-process communication provided by a sixth embodiment of the present application.

FIG. 16 is a schematic diagram of a control instruction pipeline and an image processing pipeline of a data processing system provided by a seventh embodiment of the present application.

FIG. 17 is a flowchart of a data processing method provided by a seventh embodiment of the present application.

FIG. 18 is a flowchart of a method for YUV single frame denoising provided by an eighth embodiment of the present application.

FIG. 19 is a schematic diagram of a flow framework of YUV single frame denoising provided by an eighth embodiment of the present application.

FIG. 20 is a flowchart of a method for YUV multi frame HDR provided by a ninth embodiment of the present application.

FIG. 21 is a schematic diagram of a flow framework of YUV multi frame HDR provided by a ninth embodiment of the present application.

FIG. 22 is a schematic structural diagram of a data processing apparatus provided by a tenth embodiment of the present application.

FIG. 23 is a schematic structural diagram of a data processing apparatus provided by an eleventh embodiment of the present application.

FIG. 24 is a schematic structural diagram of an electronic device provided by a twelfth embodiment of the present application.

The realization of the purpose, functional characteristics, and advantages of the present application will be further illustrated in conjunction with the embodiments and with reference to the accompanying drawings. Through the above accompanying drawings, the specific embodiments of the present application have been shown, which will be described in more detail later. These accompanying drawings and text descriptions are not intended to limit the scope of the concept of the present application in any way, but to illustrate the concept of the present application for those skilled in the art by referring to specific embodiments.

### DETAILED DESCRIPTION OF EMBODIMENTS

The exemplary embodiments will be described in detail here, and examples thereof are shown in the drawings. When the following description refers to the drawings, unless otherwise represented, the same numbers in different drawings represent the same or similar elements. The implementations described in the following exemplary embodiments do not represent all implementations consistent with the present application. On the contrary, they are merely examples of apparatuses and methods consistent with some aspects of the present application as detailed in the appended claims.

It should be noted that, in this description, the terms “include”, “comprise” or any other variants thereof are intended to cover non-exclusive inclusion, so that a process, method, object or apparatus including a series of elements not only includes those elements, but also includes other elements that are not explicitly listed, or include elements inherent to the process, method, object, or apparatus. In a case that there are no more restrictions, the element defined by the sentence “including a . . . ” does not exclude the existence of other same elements in the process, method, object, or apparatus that includes the element. In addition, components, features, and elements with the same name in different embodiments of the present application may have the same meaning or different meanings, and their specific meanings need to be determined based on their interpretation in the specific embodiment or further in conjunction with the context in the specific embodiment.

It should be understood that although the terms “first”, “second”, “third”, etc. may be used herein to describe various information, the information should not be limited to these terms. These terms are only used to distinguish the same type of information from each other. For example, without departing from the scope of this description, first information may also be referred to as second information, and similarly, the second information may also be referred to as the first information. Depending on the context, the word “if” as used herein may be interpreted as “at the time of” or “when” or “in response to determining”. Furthermore, as used herein, singular forms “a”, “one” and “the” are intended to also include plural forms, unless the context indicates to the contrary. It should be further understood that the terms “contain” and “include” indicate a presence of the described features, steps, operations, elements, components, items, categories, and/or groups, but do not exclude an existence, appearance or addition of one or more other features, steps, operations, elements, components, items, categories, and/or groups. The terms “or”, “and/or”, “include at least one of the following”, etc. used herein are interpreted as inclusive or mean any one or any combination. For example, “including at least one of the following: A, B, C” means “any one of the following: A; B; C; A and B; A and C; B and C; A, B and C”. As another example, “A, B or C” or “A, B and/or C” means “any one of the following: A; B; C; A and B; A and C; B and C; A, B and C”. An exception to this definition will occur only when the combination of elements, functions, steps or operations is inherently mutually exclusive in some ways.

It should be understood that although the various steps in the flowchart of the embodiments of the present application are displayed in sequence in accordance with the indication of arrows, these steps are not necessarily executed in sequence indicated by the arrows. Unless explicitly illustrated in this description, there is no strict order restriction on the execution of these steps, which may be executed in other orders. Moreover, at least a part of the steps in the figure may include multiple sub-steps or stages, which may not necessarily be completed at the same time instant, but may be executed at different time instants, and execution order thereof may not necessarily be sequential, but may be executed in turn or alternately with at least a part of other steps or sub-steps of other steps or stages.

Depending on the context, the words “if” and “in a case that” used here may be interpreted as “at the time of”, “when”, “in response to determining” or “in response to detecting”. Similarly, depending on the context, the phrases “if it is determined” or “if it is detected (a stated condition or event)” may be interpreted as “at the time of determining” or “in response to determining” or “at the time of detecting (the stated condition or event)” or “in response to detecting (the stated condition or event)”.

It should be noted that in this description, step signs such as S101 and S102, etc. are adopted to express the corresponding content more clearly and concisely, and do not constitute a substantive restriction on the order. During specific implementation, those skilled in the art may execute S102 first and then execute S101, etc., but these should fall within the protection scope of the preset application.

A data processing method provided by the embodiments of the present application may be applied to a computational photography scenario. Computational photography is an emerging technology that combines photography and computation to implement a novel image function. Traditional photography technologies, including film photography and digital photography, often focus more on the design of components, especially lenses and sensors; while the computational photography can break free from the limitations of the traditional photography through software and hardware collaboration, and make changes in optics, sensors, image processing, and other aspects to perform computations for digital image data and implement novel image functions. The computational photography technology is widely used in mobile terminals, monitoring terminals, machine vision and other systems, and has enormous development potential in fields such as digital photography, visual arts, visual communication, social network online sharing, digital entertainment, monitoring and multimedia.

Generally, a research on the computational photography focuses more on an algorithmic level, that is, how to develop and utilize new algorithms to implement application exploration, improve algorithm performance, and improve visual effects, and with less involvement of the entire “computational photography system”. In the following, a “data processing system” refers to a “computational photography system”. The current “data processing system” may be considered as a computer system carrying the computational photography technology. In other words, the current data processing system is formed by adding computational photography-related application software and algorithms to the computer system.

With the advancement of the computational photography technology, the computational photography has become popular on mobile terminals (such as smartphones, tablets, intelligent monitoring terminals, etc.); this type of system may be called as a “mobile terminal data processing system”, which further integrates the computational photography on mobile terminals, improves portability, popularization, and automation, and gradually plays an important role in various fields. A typical example is mobile terminal devices represented by Android phones, a Camera2 system architecture that can provide developers with great freedom and convenience in developing an images application, promoting the breadth and depth of application of the computational photography.

In addition to researching on an algorithm of the computational photography, the industry also focuses on research on the data processing system, including research on aspects such as development, integration and improvement across software and hardware levels, and improvement of software and hardware collaboration (for example, designing appropriate coupling relationships between software and hardware modules, improving the interaction efficiency between various software and hardware modules), and enhancement of compatibility, consistency and reliability of software and hardware systems. In an embodiment, the efficiency, reliability, and reusability of the research and development of the computational photography algorithm modules have always been concerned.

From the perspective of the software and hardware composition of the data processing system, the software related to the computational photography mainly includes a photography-related kernel and driver (e.g., an imaging sensor driver, an imaging auxiliary device driver), a hardware abstract layer (Hardware Abstract Layer, abbreviated as HAL) software related to a camera device, a computational photography application software (e.g., panoramic shooting, HDR synthesis, background blurring, portrait beautification, and other applications) and corresponding algorithms. The hardware related to the computational photography mainly includes a camera module (including a photosensitive chip, a lens, a focusing device, an anti-shake device, etc.), a processor, a digital signal processor, an image signal processor, an image processing unit, or other coprocessors such as an NPU, an APU, etc., an imaging auxiliary module (including a flash, a focusing device, a metering device, etc.), a memory (e.g., an internal memory, an external memory), and other modules (e.g., a display module, a communication module).

From a perspective of a hierarchical relationship in the data processing system, a hierarchical structure may be used for description.

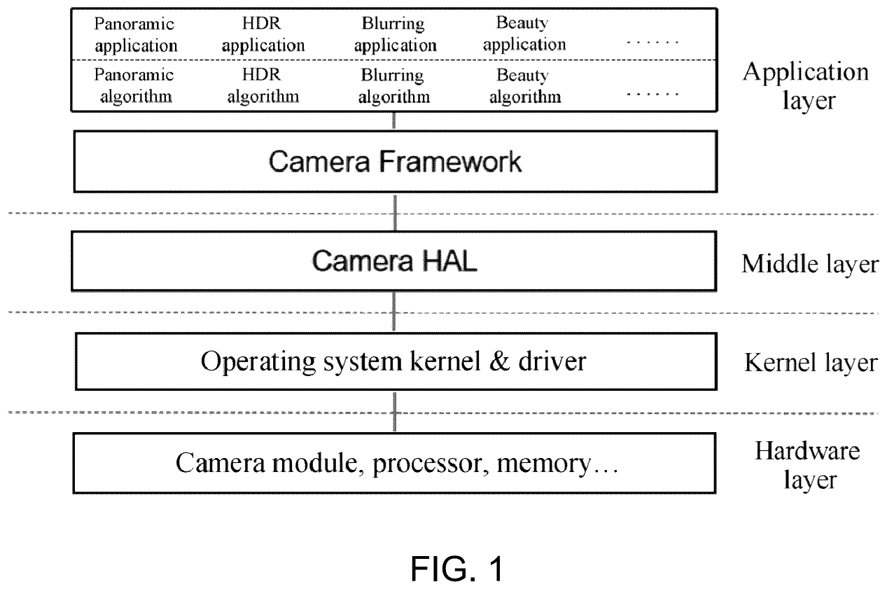

Exemplarily, FIG. 1 shows an example of a hierarchical structure of a data processing system. The hierarchical structure of the data processing system shown in FIG. 1 has the following features: first, a computational photography application software and a related algorithm module are located at an application layer. The application software captures an image by calling an application programming interface (Application Programming Interface, abbreviated as API, also known as an “interface”) of a photography system, and then independently performs subsequent image algorithm processing. Second, a hardware abstract layer HAL related to a photography hardware device is also called as a middle layer, which plays an isolation and bonding role between the application layer and the kernel layer: the HAL provides an upper layer with a photography-related interface (mainly an interface related to capturing an image by the photography hardware device), and implements a specific function of a driver module downwards (Implementation). Third, a photography-related kernel and driver module is correlated with communications of camera software and control of camera hardware in the HAL, and provides a relevant call interface upwards.

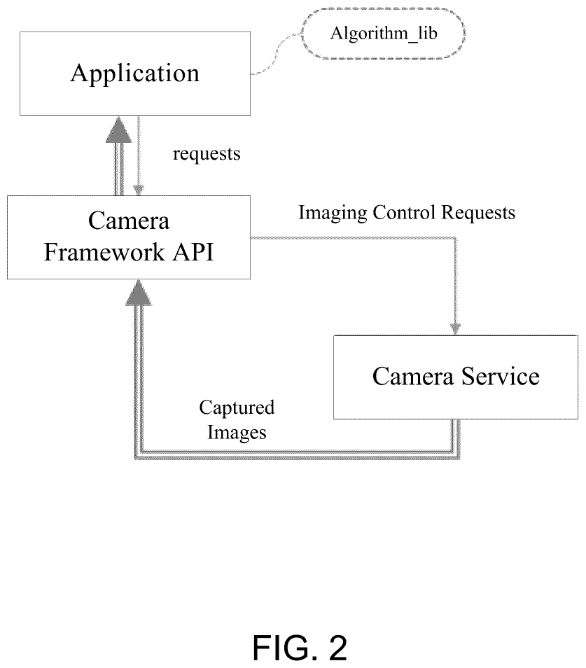

A typical implementation of the data processing system of the hierarchical structure shown in FIG. 1 is shown in FIG. 2. An application software (Application) issues requests to an interface (Camera Framework API) provided by a camera framework, sends imaging control instructions (Imaging Control Requests) downwards through the interface (Camera Framework API) provided by the camera framework, acquires captured image data (Captured Images) from a camera service located in a camera hardware abstract layer (Camera HAL), and performs a calculation in an algorithm module (Algorithm_lib) of an application software to achieve a purpose of computational photography. The data processing system of the hierarchical structure shown in FIG. 1 is usually adopted by a third-party application developer. Developers do not have an authority to modify modules below the application layer, so they can only carry out related development at the application layer. Only some possible application and algorithm modules are shown in FIG. 1 for exemplary illustration, the application and algorithm modules that may be included in the data processing system are not specifically limited.

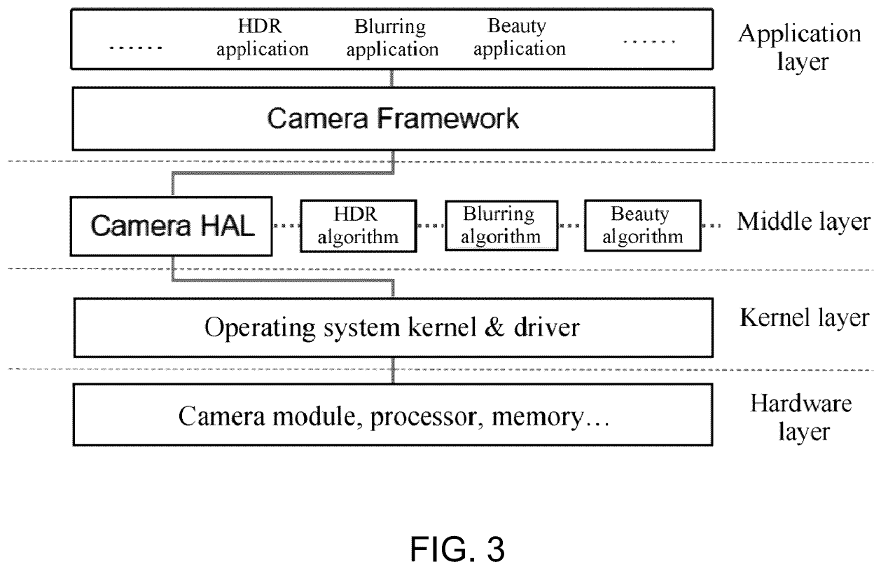

Exemplarily, FIG. 3 shows an example of another hierarchical structure of a data processing system. The hierarchical structure of the data processing system shown in FIG. 3 differs from the hierarchical structure of the data processing system shown in FIG. 1 in that: a computational photography algorithm module is located in a middle layer and integrated with a Camera HAL. An application in an application layer does not need to provide an additional algorithm module, but only needs to specify one or more algorithm modules in image processing instructions (Image Processing Requests).

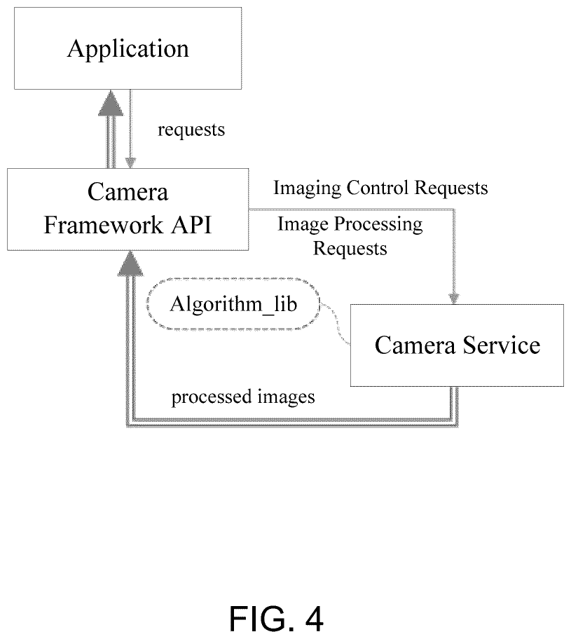

A typical implementation of the data processing system of the hierarchical structure shown in FIG. 3 is shown in FIG. 4. An application software (Application) issues requests to an interface (Camera Framework API) provided by a camera framework, sends imaging control instructions (Imaging Control Requests) and image processing instructions (Image Processing Requests) downwards through the Camera Framework API, acquires a captured image from a Camera Service, and performs calculation processing through algorithm modules on the Camera Service level, and finally feeds back processed images to the application. The data processing system of the hierarchical structure shown in FIG. 3 is usually adopted by manufacturers of a complete machine of a computational photography device or by providers of computational photography platforms. Users have an authority to design and integrate an entire computational photography pipeline. Only some possible application and algorithm modules are shown in FIG. 3 for exemplary illustration, the application and algorithm modules that may be included in the data processing system are not specifically limited.

Exemplarily, the data processing systems of the hierarchical structures shown in FIG. 1 and FIG. 3 may also be combined, and developers of computational photography application software may use self-developed algorithm modules located in the application layer, as well as integrated algorithm modules located in the middle layer.

The traditional data processing system of the hierarchical structure has the following drawbacks regardless of the computational photography algorithm modules being located in the application layer or the middle layer.

First, there is a lack of functional sharing mechanism for a computational photography algorithm module. Each application and algorithm module is independently developed by developers, making it difficult to implement functional sharing among applications, resulting in the inability to reuse the algorithm module.

Second, a computational photography pipeline is not flexible enough. The various algorithm modules integrated in the middle layer need to be compiled and linked before they can be called in the various calling modules of the computational photography pipeline. If a certain algorithm module or calling module needs to be added, deleted, or modified (for example, modifying a name, interface, or semantics of a function in a module), it may be necessary to recompile and link an associated algorithm module or calling module (which also means that the computational photography pipeline is fixed), resulting in a cumbersome development phase of the algorithm function.

Third, there is a lack of an advanced functional interface for computational photography. In the development process of application software related to computational photography, the camera module in the existing data processing system only provides relatively low-level APIs such as fundamental image frame acquisition, preview frame acquisition, video recording, camera capture parameter setting and acquisition; generally, no high-level API related to the computational photography application is provided to implement advanced functions of the computational photography image processing, such as multi frame denoising, multi frame high-dynamic range (HDR) images, portrait segmentation, etc. If similar functions need to be implemented, application developers need to independently develop corresponding algorithm modules.

Fourth, the algorithm module and call module integrated in the middle layer of the data processing system may run in the same process or different processes. If running in the same process (for example, in the same process with the Camera HAL), once a software failure occurs in the algorithm module, it will cause the entire process to crash, affecting the use of other algorithm modules and call modules in the middle layer; if running in different processes, the inter-process communication (IPC) for image data transmission between respective processes will have large overheads, which affects the efficiency of the algorithm module in computational photography image processing.

The technical solutions of the embodiments of the present application and how the technical solutions of the present application solve the above technical problem are illustrated in detail below with specific embodiments. The following specific embodiments may be combined with each other, and the same or similar concepts or processes may not be repeated in some embodiments. Embodiments of the present application will be described below with reference to the accompanying drawings.

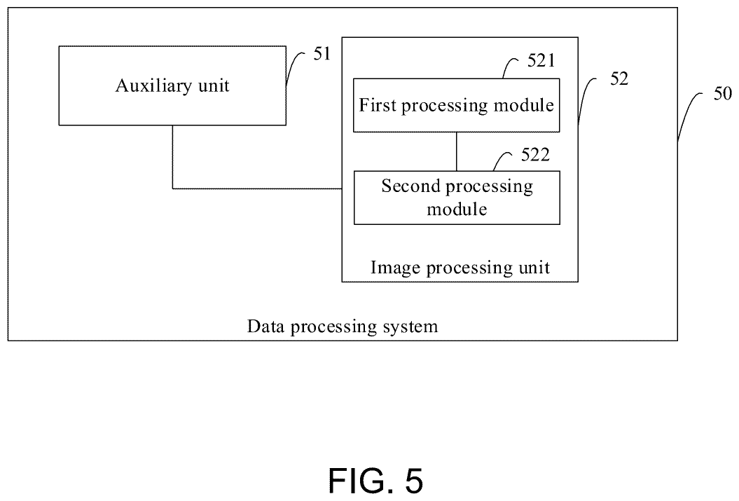

FIG. 5 is a schematic diagram of a new data processing system architecture provided by a first embodiment of the present application. As shown in FIG. 5, the data processing system 50 includes an auxiliary unit 51 and an image processing unit 52. In an embodiment, the image processing unit 52 includes: a first processing module 521 and a second processing module 522.

The first processing module 521 is configured to control, according to an image processing instruction, the second processing module 522.

The second processing module 522 is configured to perform, according to the image processing instruction, image processing on image data to obtain a target image.

Exemplarily, the second processing module may include one or more processing services (CP Service, also called as “computational photography service”) the processing service is used for performing the image processing on the image data according to the image processing instruction. The first processing module is a module that manages the processing service, that is, a service management module.

In an embodiment, a data transmission may be performed between any two of the auxiliary unit, the first processing module and the second processing module.

In an implementation, the auxiliary unit, the first processing module and the second processing module perform separate independent running.

In an embodiment, the auxiliary unit, the first processing module and the second processing module in the data processing system may all run as independent processes. These three parts are implemented separately through the independent processes. When any of the processes is problematic, there will be no impact on the running of other two processes, achieving fault isolation among these three parts and improving the stability and the reliability of the data processing system.

In an embodiment, a data transmission may be performed between any two of the auxiliary unit, the first processing module and the second processing module through an inter-process communication.

In an embodiment, the data processing system further includes an inter-process communication driver, where each of the auxiliary unit, the first processing module and the second processing module contains an inter-process communication interface. Between corresponding processes of any two of the auxiliary unit, the first processing module and the second processing module, the inter-process communication interface is used and the inter-process communication driver is utilized to implement an inter-process communication. In an embodiment, the inter-process communication driver may be located in an operating system kernel.

In an embodiment, any two of the auxiliary unit, the first processing module and the second processing module may implement an inter-process communication through a shared memory.

In an embodiment, the auxiliary unit further includes a program library for implementing an application programming interface and the inter-process communication interface.

In the embodiment, the data processing system further includes a preset module, which includes one or more algorithm library files and algorithm description metadata corresponding to each algorithm library file.

In an embodiment, any algorithm library file contains one or more algorithm modules; the algorithm description metadata corresponding to the algorithm library file is used to describe an algorithm module contained in the algorithm library file, as well as a function and a usage specification of the algorithm module. In an embodiment, the algorithm library file is a dynamic link library file or a static library file.

In an embodiment, the auxiliary unit further includes: an application programming interface. An application issues a request for acquiring the target image to the auxiliary unit by calling the application programming interface.

In an embodiment, the application programming interface is used to implement a corresponding image processing function by calling one or more algorithm modules in the algorithm library file.

For example, the image processing function may include at least one of the following:
a single frame image processing function, a multi frame image processing function, a video image processing function.

In an embodiment, the auxiliary unit is specifically configured to: parse a request for acquiring the target image issued by an application, and determine at least one of imaging control requirement information, image processing requirement information and image acquiring requirement information corresponding to the target image; determine or generate the image processing instruction according to the image processing requirement information, and issue the image processing instruction to the image processing unit.

In an embodiment, the auxiliary unit is specifically further configured to: determine or generate an imaging control instruction according to the imaging control requirement information, and issue the imaging control instruction to a camera service.

In an embodiment, the auxiliary unit is specifically further configured to: determine or generate an image acquiring instruction according to the image acquiring requirement information, and issue the image acquiring instruction to an image supply service.

Specifically, generating the image processing instruction according to the image processing requirement information by using the algorithm module in the algorithm library file includes:
determining, according to the image processing requirement information and algorithm description metadata of an algorithm module, at least one algorithm module that matches the image processing requirement information; assembling, according to the image processing requirement information, the at least one algorithm module to determine or generate the image processing instruction.

In the embodiment, the image processing unit includes the first processing module (service management module) and the second processing module (processing service).

After the auxiliary unit issues the image processing instruction to the image processing unit, the first processing module is specifically configured to:
according to the image processing instruction, if it is determined that there is a second processing module that matches the image processing instruction and is in an idle state, use the second processing module that matches the image processing instruction and is in the idle state as a second processing module corresponding to the image processing instruction.

The first processing module is further configured to:
according to the image processing instruction, if it is determined that there is a second processing module that matches the image processing instruction and the second processing module that matches the image processing instruction is in an occupied state, create a second processing module corresponding to the image processing instruction, or until the second processing module that matches the image processing instruction enters an idle state, use the second processing module that matches the image processing instruction and is in the idle state as a second processing module corresponding to the image processing instruction.

The first processing module is specifically further configured to:
according to the image processing instruction, if it is determined that there is no second processing module that matches the image processing instruction, create, according to the image processing instruction, a second processing module corresponding to the image processing instruction.

In an embodiment, the first processing module is specifically further configured to:
after using the second processing module that matches the image processing instruction and is in the idle state as the second processing module corresponding to the image processing instruction, if the second processing module corresponding to the image processing instruction is not stored in a memory, load the second processing module corresponding to the image processing instruction into the memory and start the second processing module corresponding to the image processing instruction.

The first processing module is specifically further configured to:
after returning the target image to the auxiliary unit, pause and save, or destroy, according to the image processing instruction, the second processing module.

The second processing module is further configured to: execute, through at least one thread, a processing pipeline corresponding to the image processing instruction to implement the image processing on the image data to obtain the target image.

In an embodiment, the processing pipeline corresponding to the image processing instruction includes at least one sub-pipeline, where the at least one sub-pipeline runs within one thread, or the at least one sub-pipeline is run in parallel by at least two threads.

Specifically, the second processing module creates one or more threads; through one or more threads, executes the processing pipeline corresponding to the image processing instruction according to the image processing instruction and/or image metadata to implement the image processing on the image data to obtain the target image.

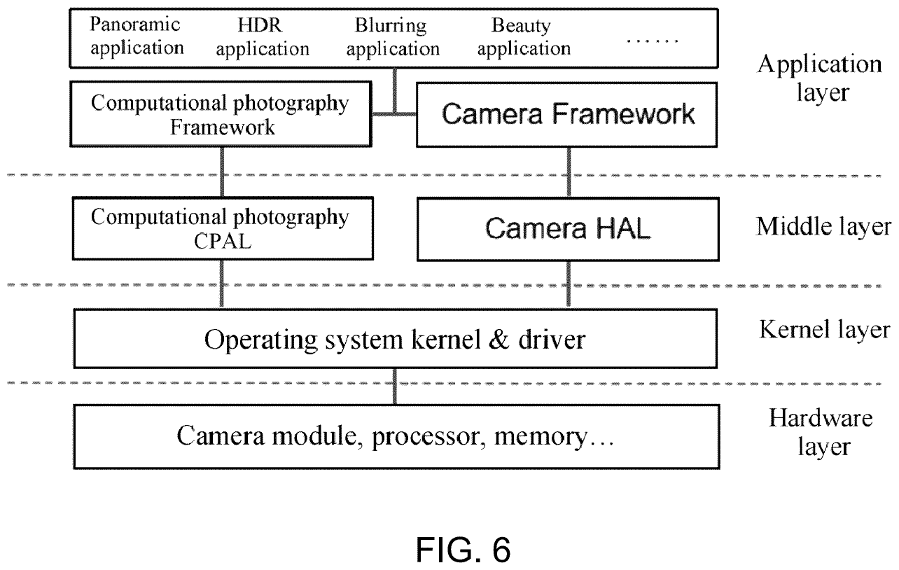

Exemplarily, FIG. 6 is a schematic diagram of a hierarchical structure of a new data processing system provided by the present application. As shown in FIG. 6, definitions and functions of respective layers in a computing system are as follows:

Application layer: including each computational photography application software and auxiliary unit (CP Framework), and Camera Framework. In an embodiment, each application software may be application software developed by roles such as data processing system vendors, platform developers, or third-party application developers; the CP Framework and the Camera Framework are software layers developed by data processing system vendors or platform developers, with an aim of providing a functional interface for the application software, shielding low-level implementation details, and simplifying application layer operations.

Middle layer: a computational photography abstract layer (CPAL) and a camera hardware abstract layer (Camera HAL) are used to abstractize an imaging control flow and an image processing pipeline of computational photography, provide an API interface for the application layer, and implement specific functions of driving modules (such as Camera drivers).

Kernel layer: referring to an operating system kernel, and related software and hardware drivers.

Hardware layer: a camera module, a processor, a memory and other hardware devices.

In the hierarchical structure of the data processing system shown in FIG. 6, the biggest difference from a hierarchical structure of a traditional data processing system is that “the auxiliary unit (CP Framework)” and “the computational photography abstract layer CPAL” are added to the data processing system shown in FIG. 6. Other parts (such as Camera Framework, Camera HAL, etc.) may be the same as those in a traditional data processing system framework, and will not be repeated here.

The technical solutions of the embodiments of the present application and how the technical solutions of the present application solve the above technical problem are illustrated in detail below with specific embodiments. The following specific embodiments may be combined with each other, and the same or similar concepts or processes may not be repeated in some embodiments. Embodiments of the present application will be described below with reference to the accompanying drawings.

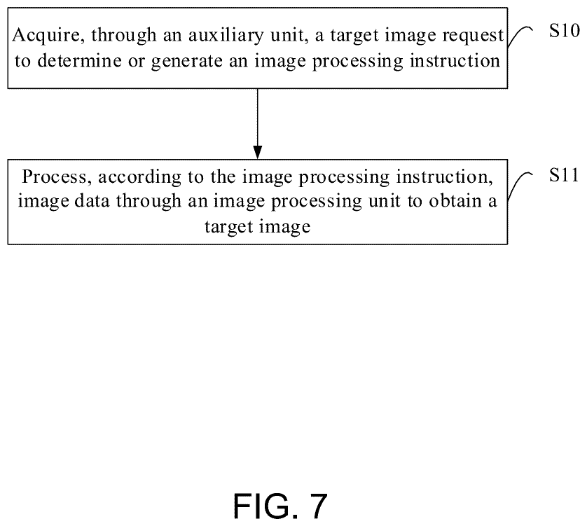

FIG. 7 is a flowchart of a data processing method provided by a second embodiment of the present application. The executive entity of the method provided in the embodiment may be an electronic device according to the data processing system in a first embodiment, for example, it may be a processing server, a data processing system development platform, a data processing system device, etc., in other embodiments, it may also be other electronic devices, which is not specifically limited here.

As shown in FIG. 7, the specific steps of the method are as follows:
step S10, acquire, through an auxiliary unit, a target image request to determine or generate an image processing instruction.

Exemplarily, the target image request is sent by an application, the auxiliary unit can receive a request for acquiring the target image issued by the application. In an embodiment, the application may be a third-party application or a native application.

The auxiliary unit may determine or generate the image processing instruction according to requirement information in the request for acquiring the target image, and issue the image processing instruction to the image processing unit.

In addition, the auxiliary unit may also receive the target image and its corresponding metadata information uploaded by a lower level module, and/or, control flow feedback metadata information. In an embodiment, controlling the flow metadata includes commanding metadata and feeding back metadata.
Step S11, process, according to the image processing instruction, image data through an image processing unit to obtain a target image.

The image processing unit can receive the image processing instruction issued by the auxiliary unit and acquire to-be-processed image data. The image data may be image data captured by a camera service, or may be image data provided by an image supply service. The source of the image data is not specifically limited in the embodiment.

In this step, through the image processing unit, the image processing on the image data may be performed according to the image processing instruction to obtain the target image.

In an embodiment, after the target image is obtained, the target image may be returned to the application through the auxiliary unit to display and/or store the target image through the application.

The embodiment is based on the above data processing system architecture shown in FIG. 5 or FIG. 6, and the data processing method based on the computational photography is implemented.

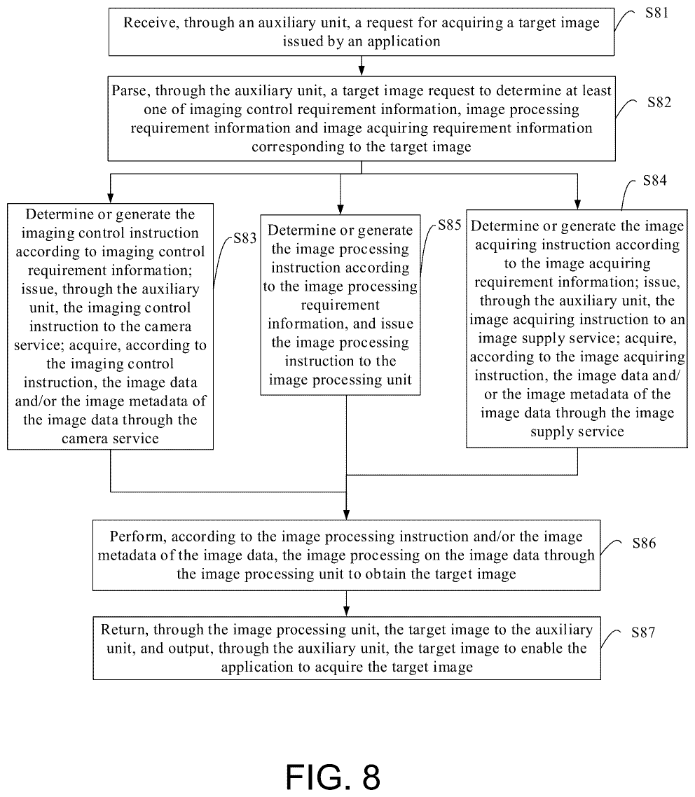

FIG. 8 is a flowchart of a data processing method provided by a third embodiment of the present application. On a basis of the above second embodiment, an overall flow of the data processing method is illustrated in detail in the embodiment. As shown in FIG. 8, the specific steps of the method are as follows:
step S81, receive, through an auxiliary unit, a request for acquiring a target image issued by an application.

Exemplarily, a target image request is sent by the application, the auxiliary unit can receive a request for acquiring the target image issued by the application. In an embodiment, the application may be a third-party application or a native application.

The auxiliary unit may determine or generate an image processing instruction according to requirement information in the request for acquiring the target image, and issue the image processing instruction to the image processing unit.
Step S82, parse, through the auxiliary unit, a target image request to determine at least one of imaging control requirement information, image processing requirement information, and image acquiring requirement information corresponding to the target image.

In the embodiment, by parsing the target image request, the auxiliary unit may determine at least one of imaging control requirement information, image processing requirement information and image acquiring requirement information corresponding to the target image. Based on the parsed requirement information, an instruction corresponding to the requirement information is generated.

If the requirement information determined by parsing contains the imaging control requirement information, step S83 needs to be executed. If the requirement information determined by parsing contains the image acquiring requirement information, step S84 needs to be executed. If the requirement information determined by parsing contains the image processing requirement information, steps S85-S86 need to be executed. If the requirement information determined by parsing includes multiple types, a corresponding step for each type of the parsed requirement information needs to be executed.

In an implementation, the target image is obtained by performing the image processing on currently captured image data. The target image request is parsed through the auxiliary unit, to determine the imaging control requirement information and the image processing requirement information corresponding to the target image.

In an embodiment, the image processing instruction may be determined or generated according to the image processing requirement information, and the corresponding imaging control instruction may be determined or generated according to imaging control requirement information.

The camera service may acquire captured image data and/or image metadata of the image data according to the imaging control instruction.

In an implementation, the target image is obtained by performing the image processing on existing image data.

The target image request is parsed through the auxiliary unit, the image processing requirement information and the image acquiring requirement information corresponding to the target image are determined. In an embodiment, the image processing instruction may be determined or generated according to the image processing requirement information, and the image acquiring instruction may be determined or generated according to the image acquiring

The image supply service may acquire the image data and/or the image metadata of the image data according to the image acquiring instruction, the image data may be stored image data.

In an implementation, the current captured image data needs to be combined with existing image data to obtain the target image by performing image processing.

The target image request is parsed through the auxiliary unit to determine the imaging control requirement information, the image processing requirement information, and the image acquiring requirement information corresponding to the target image.

In an embodiment, the image processing instruction may be determined or generated according to the image processing requirement information, the corresponding imaging control instruction may be determined or generated according to the imaging control requirement information, and the image acquiring instruction may be determined or generated according to the image acquiring requirement information.

The camera service may acquire the captured image data and/or the image metadata of the image data according to the imaging control instruction. At the same time, the image supply service may acquire the required existing image data and/or the image metadata of the image data according to the image acquiring instruction.
Step S83, determine or generate the imaging control instruction according to the imaging control requirement information; issue, through the auxiliary unit, the imaging control instruction to the camera service; acquire, according to the imaging control instruction, the image data and/or the image metadata of the image data through the camera service.

In an embodiment, after the image data and the image metadata of the image data are acquired, the image data and the image metadata are transmitted to the image processing unit through the camera service.

In an embodiment, after the image data and the image metadata of the image data are acquired, the image data and the image metadata are transmitted to a basic processing unit (basic image processing unit) through the camera service. The basic processing unit transmits processed image data and image metadata to the image processing unit.
Step S84, determine or generate the image acquiring instruction according to the image acquiring requirement information; issue, through the auxiliary unit, the image acquiring instruction to an image supply service; acquire, according to the image acquiring instruction, the image data and/or the image metadata of the image data through the image supply service.

In an embodiment, after the image data and the image metadata of the image data are acquired, the image data and the image metadata are transmitted to the image processing unit by the image supply service.
Step S85, determine or generate the image processing instruction according to the image processing requirement information, and issue the image processing instruction to the image processing unit.

In this step, the image processing instruction may be generated according to the image processing requirement information by using an algorithm module in an algorithm library file.
Step S86, perform, according to the image processing instruction and/or the image metadata of the image data, the image processing on the image data through the image processing unit to obtain the target image.

In the embodiment, the image processing unit includes a first processing module (service management module) and a second processing module (processing service).

This step may be implemented in the following manners:
acquiring the processing service corresponding to the image processing instruction according to the image processing instruction through the service management module; performing the image processing on the image data according to the image processing instruction and/or the image metadata through the processing service to obtain the target image.
Step S87, return, through the image processing unit, the target image to the auxiliary unit, and output, through the auxiliary unit, the target image to enable the application to acquire the target image.

In the embodiment, the auxiliary unit, the service management module and the processing service in the data processing system run independently.

In an embodiment, the auxiliary unit, the service management module and the processing service all run as independent processes. These three parts are implemented separately through the independent processes. When any of the processes is problematic, there will be no impact on the running of other two processes, achieving fault isolation among these three parts and improving the stability and the reliability of the data processing system.

A data transmission may be performed between any two of the auxiliary unit, the service management module and the processing service through an inter-process communication.

In an embodiment, the data processing system further includes an inter-process communication driver located in an operating system kernel, and each of the auxiliary unit, the service management module and the processing service contains an inter-process communication interface. Between corresponding processes of any two of the auxiliary unit, the service management module and the processing service, the inter-process communication interface is used and the inter-process communication driver is utilized to implement an inter-process communication.

In an embodiment, any two of the auxiliary unit, the service management module and the processing service may implement an inter-process communication therebetween through a shared memory.

The embodiment provides an overall process of implementing the data processing method according to the data processing system provided by the first embodiment.

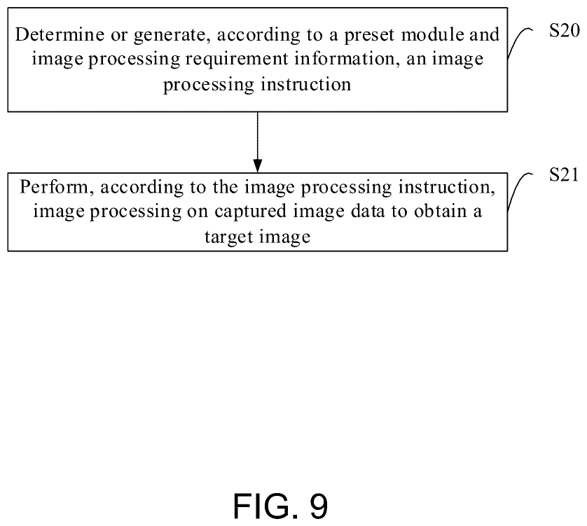

FIG. 9 is a flowchart of a data processing method provided by a fourth embodiment of the present application. The executive entity of the method provided in the embodiment may be an electronic device with a computational photography function, for example, it may be a processing server, a data processing system development platform, a data processing system device, etc., in other embodiments, it may also be other electronic devices, which is not specifically limited here.

As shown in FIG. 9, the specific steps of this method are as follows:
step S20, determine or generate, according to a preset module and image processing requirement information, an image processing instruction.

When performing image processing is required, the image processing instruction is determined or generated according to the image processing requirement information and by using the preset module.

In the embodiment, the preset module provided by the data processing system includes one or more algorithm modules. When performing the image processing is required, the algorithm module provided by the data processing system is used for assembling, to generate the image processing instruction (Image Processing Requests) according to the image processing requirement information. The image processing instruction may be described with image processing metadata, containing computational photography image processing logic data generated according to one or more algorithm modules, which can implement the reuse of the algorithm module(s), and simplify a development process, and improve the development efficiency of the algorithm module(s).
Step S21, perform, according to the image processing instruction, image processing on captured image data to obtain a target image.

After the image processing instruction is generated, one or more algorithm modules are called according to the image processing instruction to perform the image processing on the captured image data to obtain the target image.

In the embodiment of the present application, the preset module containing one or more algorithm modules is provided in the data processing system. When performing the image processing is required, the image processing instruction is generated according to the image processing requirement information and by using the algorithm module provided by the data processing system; the image processing is performed on the captured image data according to the image processing instruction to obtain the target image; the reuse of the algorithm module can be achieved and the development process can be simplified, and the development efficiency of the algorithm module can be improved.

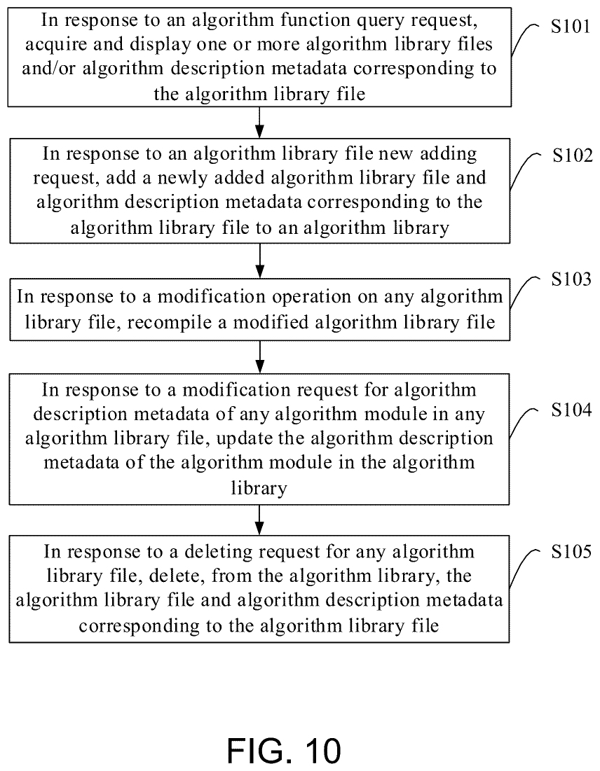

FIG. 10 is a flowchart of a data processing method provided by a fifth embodiment of the present application. On a basis of any of the above embodiments, the specific implementation of the data processing method will be illustrated in detail in the embodiment.

In the embodiment, the data processing system provides a preset module, including one or more algorithm library files, and algorithm description metadata (Algorithm Metadata) corresponding to the one or more algorithm library files. The preset module may be an algorithm library.

In an embodiment, any algorithm library file contains one or more algorithm modules; the algorithm description metadata is used to describe an algorithm module contained in any algorithm library file, and a function and usage standards of the algorithm module.

Exemplarily, the algorithm library file may be a dynamic link library file, and any dynamic link library file may contain one or more algorithm modules. By means of the dynamical link library file, the plugin management of the algorithm module can be achieved, reusing of the algorithm module can be achieved, a development process can be simplified, and the development efficiency of the algorithm module can be improved. In an embodiment, the dynamic link library file is a binary library file.

In an embodiment, the algorithm library file may also be a static library file, which may be stored in a memory as a static information package (such as a file, a file package, or other forms).

In an embodiment, before the image processing is performed on the captured image data according to the image processing instruction to obtain the target image, the used dynamic link library file is loaded into the memory according to the image processing instruction.

As shown in FIG. 10, the specific steps of this method are as follows:
step S101, in response to an algorithm function query request, acquire and display one or more algorithm library files and/or algorithm description metadata corresponding to the algorithm library file.

In the embodiment, the auxiliary unit provides an advanced functional interface for computational photography. A user may query a list of algorithm modules provided by the auxiliary unit; may select which algorithm modules to adopt or not to adopt, select an order in which the selected algorithm modules are called to implement new algorithm functions.

The auxiliary unit (CP Framework) is a computational photography framework established for the convenience of application development. The CP Framework contains a collection of APIs, providing a high-level functional API for the computational photography, encapsulating a detail of bottom-level image processing, only providing API interfaces upwards, and entrusting the image processing requirement of the application to a lower-level Camera Service and CP Service for implementation.

Specifically, the auxiliary unit provides an application programming interface to an application, and the application issues a request to the auxiliary unit through the application programming interface; the application programming interface is used to implement a corresponding computational photography image processing function by calling one or more algorithm modules in the algorithm library file.

In an embodiment, the computational photography image processing function provided by the CP Framework includes at least one of the following: a single frame image processing function, a multi frame image processing function, and a video image processing function.

Exemplarily, a high-level function of the computational photography includes but is not limited to: the single frame image processing function, the multi frame image processing function, and the video image processing function.

Exemplarily, a developer of a computational photography application or a developer of a data processing system platform may query the request by submitting the algorithm function to the auxiliary unit. The auxiliary unit can acquire and display the algorithm description metadata corresponding to one or more algorithm library files. The developer may know the function and usage standards of each existing algorithm module in the algorithm library file by viewing the algorithm description metadata corresponding to the algorithm library file. Thereby based on the algorithm description metadata, one or more algorithm modules are selected for use, and a calling order of the algorithm module(s) is specified to implement the function of the algorithm module(s), or a new algorithm function is implemented based on the existing algorithm module.
Step S102, in response to an algorithm library file new adding request, add a newly added algorithm library file and algorithm description metadata corresponding to the algorithm library file to an algorithm library.

In an embodiment, at least one algorithm module in the newly added algorithm library file is assembled from the existing algorithm modules in the algorithm library in accordance with a specific logical relationship.

In the embodiment, a user may also add the new algorithm library file to the algorithm library to add a new algorithm module.

Specifically, the user sends an algorithm library file new adding request to the auxiliary unit, where the new adding request includes a to-be-added algorithm library file and algorithm description metadata corresponding to the algorithm library file. The auxiliary unit may add the newly added algorithm library file and the algorithm description metadata corresponding to the algorithm library file to an algorithm library.

A computational photography algorithm (CPA) provider (CPA provider) may register a new algorithm module with the algorithm library through this step.
Step S103, in response to a modification operation on any algorithm library file, recompile a modified algorithm library file.

In the embodiment, the user may perform a modification operation on the algorithm library file in the algorithm library, including: an operation of adding a new algorithm module to the algorithm library file; an operation of modifying an algorithm module in the algorithm library file; an operation of deleting an algorithm module from the algorithm library file.

When any algorithm library file is modified, simply recompile a currently modified algorithm library file, which will not affect a calling module and an algorithm module in a further algorithm library file; and there is no need to compile and link the entire middle layer, simplifying a compiling and linking process for the algorithm module.
Step S104, in response to a modification request for algorithm description metadata of any algorithm module in any algorithm library file, update the algorithm description metadata of the algorithm module in the algorithm library.

After the algorithm module in the algorithm library file is modified, it may be necessary to synchronously modify the algorithm description metadata corresponding to the algorithm module.

If it is necessary to modify the algorithm description metadata corresponding to any algorithm module, the user may send the modification request for the algorithm description metadata of the algorithm module to the auxiliary unit, and the modification request includes the modified algorithm description metadata. The auxiliary unit updates the algorithm description metadata of the algorithm module in the algorithm library according to the modified algorithm description metadata.
Step S105, in response to a deleting request for any algorithm library file, delete, from the algorithm library, the algorithm library file and algorithm description metadata corresponding to the algorithm library file.

In the embodiment, a deletion operation for any algorithm library file in the algorithm library is supported.

When it is necessary to delete any algorithm library file in the algorithm library, the user may send a deletion request for the algorithm library file to the auxiliary unit. The auxiliary unit deletes the algorithm library file and algorithm description metadata corresponding to the algorithm library file from the algorithm library.

The various steps in the embodiment are executed when the corresponding request or operation is triggered. In the embodiment, only the sequential execution of above steps S101-S105 is used as an example for exemplary illustration. In other embodiments, there may be a different execution order of above steps S101-S105.

In the embodiment of the present application, the data processing system provides a preset module, which includes one or more algorithm library files and algorithm description metadata corresponding to the one or more algorithm library files. The data processing system also provides operations such as adding, deleting, and modifying the algorithm library file, the algorithm module, and their corresponding algorithm description metadata in the preset module, which can implement a new algorithm function on a basis of the existing algorithm module in the algorithm library file by reusing the existing algorithm module, and implement plugin management of the algorithm module, simplify a development process, and improve development efficiency of the algorithm module.

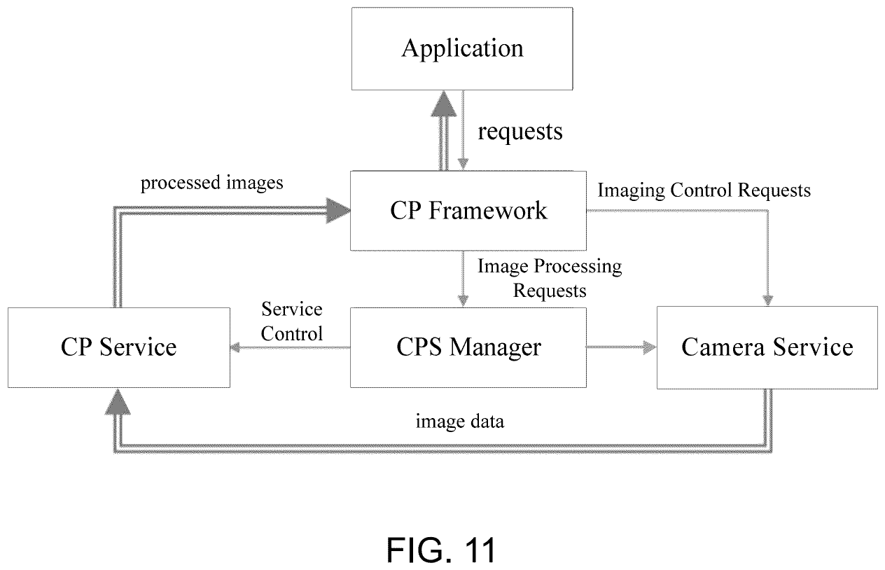

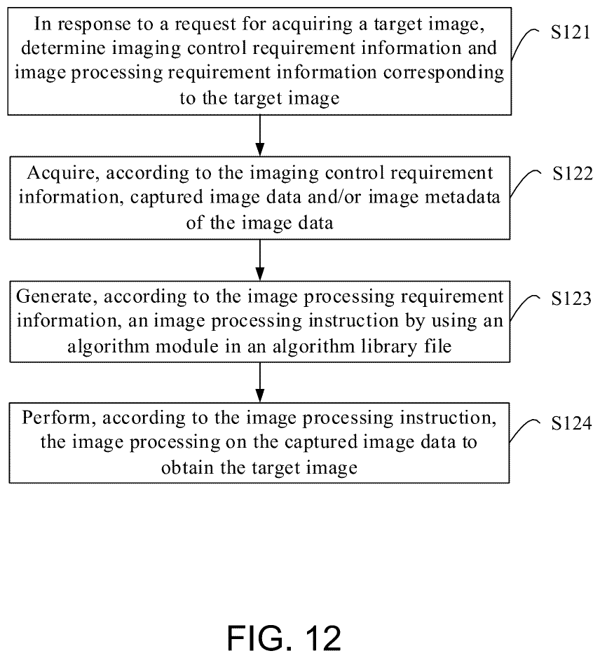

FIG. 11 is a schematic diagram of a control instruction pipeline and an image processing pipeline of a data processing system provided by a sixth embodiment of the present application; FIG. 12 is a flowchart of a data processing method provided by a sixth embodiment of the present application. On a basis of the above fifth embodiment, a specific implementation of a data processing pipeline will be exemplarily illustrated in the embodiment.

Based on the data processing system of the hierarchical structure as shown in FIG. 6, FIG. 11 shows the control instruction pipeline and the image processing pipeline in one situation. In an embodiment, a control instruction may include an imaging control instruction (Imaging Control Requests), an image processing instruction (Image Processing Requests), and feedback information for the imaging control instruction and the image processing instruction.

As shown in FIG. 11, the control instruction pipeline is as follows:
S111, an application issues a request (requests) to an auxiliary unit (CP Framework).
S112, the CP Framework parses the request and converts the request into two types of instructions: the imaging control instruction (Imaging Control Requests) and the image processing instruction (Image Processing Requests). The CP Framework sends the imaging control instruction to the camera service and sends the image processing instruction to a service management module (CPS Manager).
S113, the CPS Manager creates, according to the image processing instruction, a corresponding processing service (CP Service) and performs a service control on the CP Service.

In addition, during the image processing process, if it is found that the captured image data needs to be acquired from the Camera Service, the CPS Manager may also send an instruction to the Camera Service to acquire required image data.

As shown in FIG. 11, the image processing pipeline is as follows:
S114, the Camera Service performs, according to the imaging control instruction, imaging to obtain captured image data, and delivers the captured image data to the CP Service.
S115, the CP Service performs, according to control data of the CPS Manager, image processing on the captured image data, and returns a target image after processing (processed images) to a CP Framework API.
S116, the CP Framework API returns the target image after the processing to the application.

In an embodiment, a transmission of the image data among the Camera Service, the CP Service and the CP Framework API may be performed by means of a shared memory or an efficient inter-process communication.

In conjunction with the hierarchical structure of the data processing system provided in FIG. 6 and the control instruction pipeline and image processing pipeline shown in FIG. 11, as shown in FIG. 12, specific steps of the data processing method are as follows:
step S121, in response to a request for acquiring a target image, determine imaging control requirement information and image processing requirement information corresponding to the target image.

In an embodiment, the request for acquiring the target image may be a request issued by an application layer to an auxiliary unit, for acquiring the target image. For example, the request for acquiring the target image may be a request sent from a user to capture a portrait image, a recording request, a beauty shooting request, etc. through a camera application on a mobile terminal.

In an implementation, based on the hierarchical structure of the data processing system shown in FIG. 6, in the step, the request for acquiring the target image issued by the application is received through the auxiliary unit; the request is parsed through the auxiliary unit, to determine the imaging control requirement information and the image processing requirement information corresponding to the target image.

In an embodiment, the imaging control requirement information includes requirement information related to imaging, such as an imaging type (including photographing, recording, preview, etc.), a control instruction of a camera unit and an imaging auxiliary unit (such as camera selection, focus control, zoom control, aperture adjustment, flash control, auxiliary focus control, color temperature measurement control, etc.), and an interactive related instruction between the Camera Service and the CPS.

The image processing requirement information includes relevant requirement information for acquiring the target image by performing the image processing on the captured image, which may be basic image processing or computational photography image processing. For example, the basic image processing may include: color correction, demosaic, level noise removal, etc. The computational photography image processing may include: portrait beauty, facial tracking, a portrait style, etc.
Step S122, acquire, according to the imaging control requirement information, captured image data and/or image metadata of the image data.

After the imaging control requirement information is determined, the captured image data and/or image metadata of the image data may be acquired according to the imaging control requirement information.

In an embodiment, the image metadata of the image data is used to describe data of the image data, which may include a size, a resolution, an image format, image semantic information, etc. of the image data.

In an implementation, in this step, an imaging control instruction is generated according to the imaging control requirement information through the auxiliary unit, and the imaging control instruction is sent to the camera service; the captured image data and the image metadata of the image data are acquired according to the imaging control instruction through the camera service.

In an embodiment, the imaging control instruction may be described by using control instruction metadata, including control information required for image capturing.

In an embodiment, after the captured image data and image metadata of the image data are acquired according to the imaging control instruction through the camera service, the image data and the image metadata are transmitted to a processing service through the camera service.
Step S123, generate, according to the image processing requirement information, an image processing instruction by using an algorithm module in an algorithm library file.

In an implementation, based on the hierarchical structure of the data processing system shown in FIG. 6, in this step, the image processing instruction is generated according to the image processing requirement information by using the algorithm module in the algorithm library file through the auxiliary unit.

Specifically, the generating, according to the image processing requirement information, the image processing instruction by using the algorithm module in the algorithm library file may be implemented in the following ways:
determining, according to the image processing requirement information and algorithm description metadata of an algorithm module, at least one algorithm module that matches the image processing requirement information; assembling, according to the image processing requirement information, the at least one algorithm module to generate the image processing instruction.

In an embodiment, the image processing instruction may be described with image processing metadata, containing image processing logic data generated according to one or more algorithm modules. The image processing instruction is description data of image processing logic to be implemented, and is not implementation of specific processing logic.

Specifically, the auxiliary unit may match the algorithm description metadata of each algorithm module in the algorithm library file according to the image processing requirement information, determine one or more algorithm modules that match the image processing requirement information, and assemble one or more algorithm modules matching the image processing requirement information according to the image processing requirement information, to generate the image processing metadata and obtain the image processing instruction.

In an embodiment, after the image processing instruction is generated, the image processing instruction is sent to a service management module through the auxiliary unit.
Step S124, perform, according to the image processing instruction, the image processing on the captured image data to obtain the target image.

After the image processing instruction is obtained, the image processing is performed on the captured image data according to the image processing instruction to obtain the target image.

In an implementation, based on the hierarchical structure of the data processing system shown in FIG. 6, in this step, the processing service corresponding to the image processing instruction is acquired through the service management module; the image processing is performed on the image data according to the image processing instruction and the image metadata through the processing service to obtain the target image.

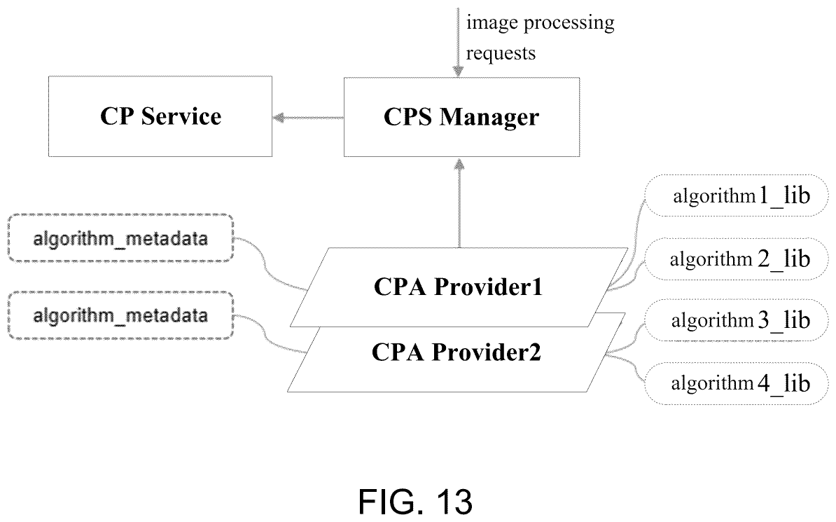

Exemplarily, as shown in FIG. 13, it is assumed that CPA provider1 has registered, with a preset module (algorithm library), algorithm library files algorithm1_lib and algorithm2_lib and algorithm description metadata corresponding to algorithm modules in the algorithm library files. CPA provider2 has registered, with the preset module, algorithm library files algorithm3_lib and algorithm4_lib and algorithm description metadata corresponding to algorithm modules in the algorithm library files. The CPS Manager dynamically creates the processing service (CP Service) corresponding to the image processing instruction, according to the image processing instruction, the algorithm library files and the algorithm description metadata provided by each CPA provider in the preset module, and the processing service is used to implement the image processing corresponding to the image processing instruction. Through a working manner of the CPS Manager and the CPA Provider, “plugin” management of a computational photography algorithm module may be achieved.

In an embodiment, an occasion for creating the processing service may be determined depending on a specific situation, where the processing service may be pre-created in accordance with a preset scheme (default scheme) when the data processing system starts, to improve a response speed to the Application; or, the processing service is created temporarily when needed according to a request of the application; or to the processing service may be created by loading and running the previously saved CP Service. Thereby, a specific functional requirement of the application is met.

In the embodiment, after the target image is fed back to the auxiliary unit through the processing service, the processing service is paused and saved, or is destroyed according to the image processing instruction through the service management module.

Exemplarily, according to the image processing instruction, if current image processing is a multi frame image processing function, since there is the same computational photography processing for multiple frames of images, the processing service corresponding to the image processing instruction may be paused and saved after the processing on one frame of image is completed. This processing service may continue to be used to perform the same image processing on the next frame of image, thereby improving the efficiency of the image processing.

Exemplarily, according to the image processing instruction, if there is no image that requires the same image processing subsequently, the processing service corresponding to the image processing instruction may be destroyed to save a CPU and a storage resource.

In an embodiment, the processing service may be temporarily stored in a memory or an external memory.

In an embodiment, the processing service corresponding to the image processing instruction is acquired through the service management module, which may be implemented in the following ways:
through the service management module, according to the image processing instruction, if it is determined that there is no processing service that matches the image processing instruction, a processing service corresponding to the image processing instruction is created according to the image processing instruction;
through the service management module, according to the image processing instruction, if it is determined that there is a processing service that matches the image processing instruction and is in an idle state, the processing service that matches the image processing instruction and is in the idle state is used as a processing service corresponding to the image processing instruction;
through the service management module, according to the image processing instruction, if it is determined that there is a processing service that matches the image processing instruction and the processing service that matches the image processing instructions is in an occupied state, a processing service corresponding to the image processing instruction is created, or, until the processing service that matches the image processing instruction enters an idle state, the processing service that matches the image processing instruction and is in the idle state is used as a processing service corresponding to the image processing instruction.

In an embodiment, after the processing service that matches the image processing instruction and is in the idle state is used as the processing service corresponding to the image processing instruction, if the processing service corresponding to the image processing instruction is not stored in a memory, the processing service corresponding to the image processing instruction is loaded into the memory and the processing service corresponding to the image processing instruction is started.

In an embodiment, based on a preset processing service selection strategy, the processing service corresponding to the image processing instruction is acquired according to a using situation of a system resource such as the memory and CPU, and a priority of the image processing instruction. The processing service selection strategy may be set and adjusted according to the needs of actual application scenarios, which is not specifically limited here.

For example, when an idle rate of the memory, CPU and other resources in the system is high, if there is a processing service that matches the image processing instruction and the processing service that matches the image processing instruction is in the occupied state, the processing service corresponding to the image processing instruction is recreated to improve the efficiency of the image processing.

For example, a current image processing instruction is a high priority image processing instruction, if there is the processing service that matches the image processing instruction, and the processing service that matches the image processing instruction is in the occupied state, the processing service corresponding to the image processing instruction is recreated to improve the efficiency of the image processing.

For example, a current image processing instruction is a high priority image processing instruction, if an using rate of the memory, CPU and other resources in the system is high, other low priority processing services may also be paused to free up more memory, CPU and other resources, and the image processing instruction with the high priority may be prioritized.

In an embodiment, through the processing service, the image processing may be performed for the image data according to the image processing instruction and the image metadata to obtain the target image, which may be implemented in the following ways:
through the processing service, according to the image processing instruction and the image metadata, an algorithm pipeline corresponding to the image processing instruction is executed to implement the image processing on the image data to obtain the target image.

Specifically, through the processing service, one or more threads are created; through one or more threads, a processing pipeline corresponding to the image processing instruction is executed according to the image processing instruction and the image metadata to implement the image processing on the image data and obtain the target image.

In an embodiment, the processing pipeline corresponding to the image processing instruction is executed, which includes one or more sub-pipelines, where the one or more sub-pipelines run within one thread, or the one or more sub-pipelines are run in parallel by multiple threads.

Exemplarily, once the processing service is started, it runs as an independent process. During a runtime of the processing service process, one or more threads will be started as needed, each thread is used to perform a once computational photography pipeline (CP Session) on the image.

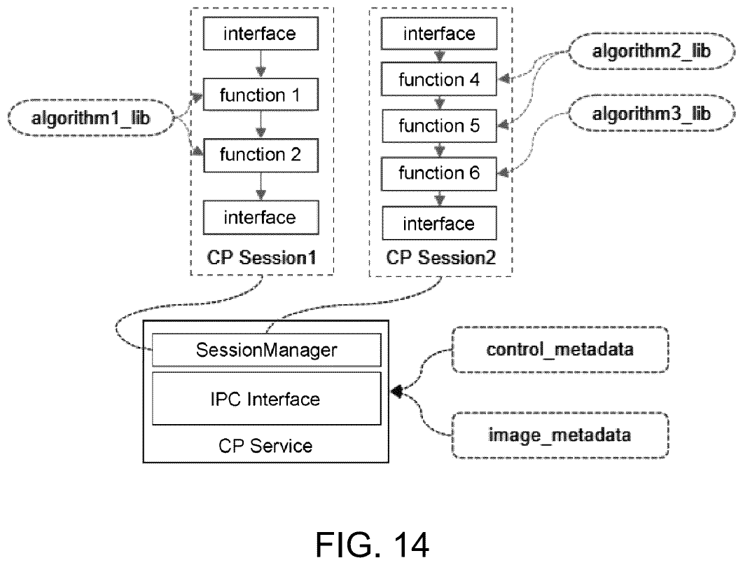

Exemplarily, as shown in FIG. 14, the CP Service may include but is not limited to the following modules:
Session Manager: responsible for creating, running, managing, and destroying a Session (such as CP Session1 and CP Session2 in FIG. 14).
IPC interface: responsible for a communication between the CP Service and other processes.

In an embodiment, the algorithm module used in the CP Session may come from one or more CPA Providers. When creating a CP Service, the CPS Manager will select an algorithm library file and an algorithm module in the algorithm library file according to the image processing instruction and the image metadata of the captured image data delivered by the CP Framework, as well as according to algorithm description metadata (algorithm_metadata) of the algorithm module in each provided algorithm library file. According to logic of a pipeline of the image processing instruction provided by the CP Framework, matching and assembling combination are performed to form one or more sub-pipelines (Sub-Pipeline), each sub-pipeline is used as a Session running in a threaded manner.

The CP Service reads the captured image data and the image metadata of the image data as well as control data (which is used to control a lifecycle of the CP Service) through an IPC Interface. The image data is processed through various sub-pipelines, to obtain a target image after the processing, and then the target image is outputted through the IPC Interface.

In an embodiment, through the processing service, the image processing is performed on the image data according to the image processing instruction and the image metadata. After the target image is obtained, the target image is fed back to the auxiliary unit through the processing service; the target image is fed back to the application through the auxiliary unit.

In an implementation, the auxiliary unit, the service management module and the processing service all run as independent processes.

The CP Manager, the CP Service and the CP Framework all run as independent processes, providing a fault isolation mechanism. A failure of the algorithm module in the CP Service will not affect other processes.

In an implementation, a data transmission may be performed among the auxiliary unit, the service management module and the processing service through a shared memory.

In an embodiment, through the camera service, the image data and the image metadata may be transmitted to the processing service, which may be implemented in the following ways:
store, through the camera service, the target image and the image metadata in a shared memory; acquire, through the processing service, the target image and the image metadata from the shared memory.

In an embodiment, through the processing service, the target image may be fed back to the auxiliary unit may be implemented as follows:
store, through the processing service, the target image in the shared memory; acquire, from the shared memory, the target image through the auxiliary unit.

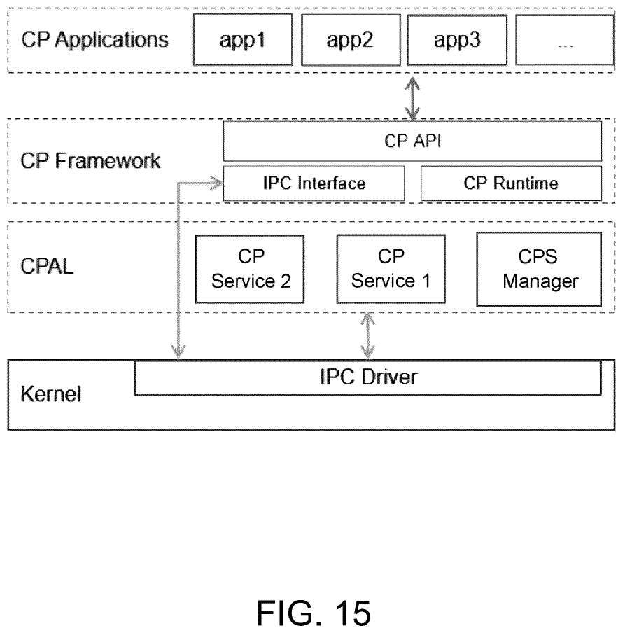

In an implementation, a kernel module that supports a computational photography inter-process communication may be added to an operating system kernel. The data transmission among the auxiliary unit, the service management module and the processing service may be efficiently performed through an inter-process communication. An example implementation is shown in FIG. 15.

The application layer includes: computational photography applications (i.e., CP Applications), such as app1, app2, app3, etc. in FIG. 15.

The CP Framework includes but is not limited to the following modules:
Computational Photography API: also called as CP API or CP Framework API, an API for providing the computational photography to implement downward sending of the imaging processing instruction and the image processing instruction.
IPC interface: efficient inter-process communication is implemented by utilizing an IPC driver (i.e., IPC Driver) in a kernel (Kernel).
Computational photography runtime library: i.e., CP runtime, used for implementing the CP API and the IPC interface.

The CPAL includes but is not limited to the following modules:
Processing service (Computational Photography Service, abbreviated as CP service or CPS): used for implementing a specific function of the computational photography, such as CP Service1 and CP Service2 shown in FIG. 15.
Service management module (Computational Photography Service Manager, abbreviated as CPS Manager): used for creating and managing the CP Service.
IPC driver: also called as an IPC Driver, which is located in an IPC of the kernel to implement the efficient inter-process communication. The process here may be a CP Application process or a CP Service process.

In an embodiment, a process communication among the CP Framework, the Camera Framework, the CP service and the Camera HAL adopts an efficient IPC manner based on a kernel IPC Driver.

In an embodiment, considering a balance between the communication efficiency and the security, the IPC Driver here may adopt the IPC Driver similar to a Binder Driver in an Android system, which is not repeated here. In order to improve the transmission efficiency, the IPC Driver may adopt memory file mapping (mmap) to implement sharing of image data between various processes, avoiding multiple reads and writes of image data between processes to the most extent. The IPC Driver not only ensures the efficiency of the inter-process communication, but also implements inter-process access control, ensuring the security of the inter-process communication.

The embodiment of the present application provides a hierarchical structure of a new data processing system, which provides a communication mechanism between computational photography applications or computational photography algorithm modules, and uses this communication mechanism to implement an interaction and a functional reuse between various applications or algorithm modules; implements a “plugin” management mechanism for a computational photography algorithm module, adding, deleting and modifying of the algorithm module do not need recompilation and linking of the Framework layer and the middle layer, achieving reusing of the algorithm module, simplifying the development process, and improving the development efficiency of the algorithm module; provides an advanced functional interface of the computational photography for the computational photography application layer; achieves a fault isolation mechanism, and the failure of the algorithm module will not cause a serious failure in other related processes; achieves efficient data sharing between algorithm modules, no frequent copying of data between modules is needed (especially a large amount of the image data), and improves the data transmission efficiency.

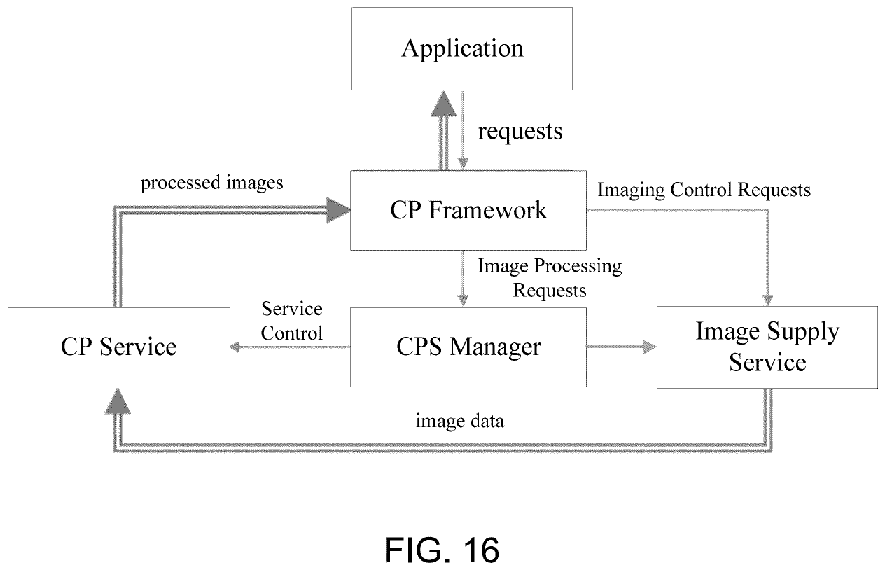

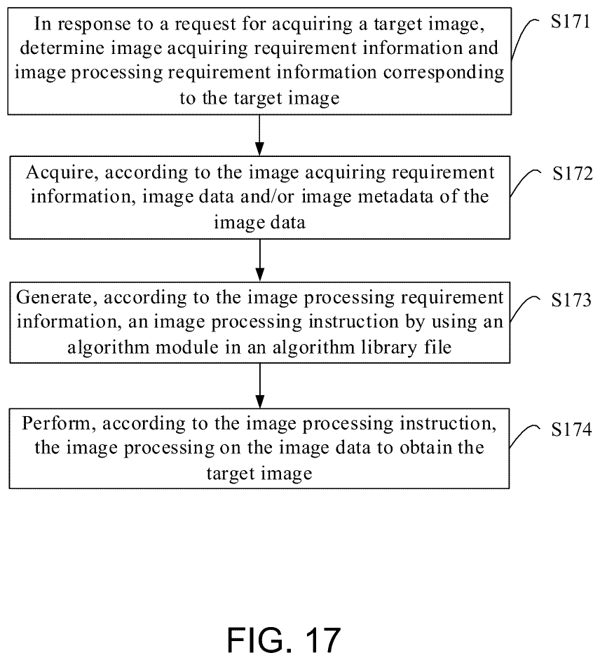

FIG. 16 is a schematic diagram of a control instruction pipeline and an image processing pipeline of a data processing system provided by a seventh embodiment of the present application; FIG. 17 is a flowchart of a data processing method provided by a seventh embodiment of the present application. On a basis of the above fifth embodiment, a specific implementation of a data processing pipeline is exemplarily illustrated in the embodiment.

Based on the data processing system of the hierarchical structure as shown in FIG. 6, FIG. 16 shows the control instruction pipeline and the image processing pipeline in another situation. The difference from FIG. 11 is that in the embodiment, an image supply service is used to replace a camera service to provide image data to an auxiliary unit (CP Framework) and/or a service management module (CPS Manager).

In an embodiment, a control instruction may include an imaging control instruction (Imaging Control Requests), an image processing instruction (Image Processing Requests), and feedback information for the imaging control instruction and the image processing instruction.

As shown in FIG. 16, a control instruction pipeline is as follows:
S161, an application issues a request (requests) to the auxiliary unit (CP Framework).
S162, the CP Framework parses the request and converts the request into two types of instructions: the imaging control instruction (Imaging Control Requests) and the image processing instruction (Image Processing Requests). The CP Framework sends the imaging control instruction to the image supply service and sends the image processing instruction to the service management module (CPS Manager).
S163, the CPS Manager creates, according to the image processing instruction, a corresponding processing service (CP Service) and performs a service control (Service Control) on the CP Service.

In addition, during the image processing process, if it is found that the captured image data needs to be acquired from the image supply service, the CPS Manager may also send an instruction to the image supply service to acquire required image data.

As shown in FIG. 16, the image processing pipeline is as follows:
S164, the image supply service performs, according to the imaging control instruction, imaging to obtain captured image data (image data), and delivers the captured image data to the CP Service.
S165, the CP Service performs, according to control data of the CPS Manager, image processing on the captured image data, and returns a target image after processing (processed images) to the CP Framework API.
S166, the CP Framework API returns the target image after the processing to the application.

In an embodiment, a transmission of the image data among the Image Supply Service, the CP Service and the CP Framework API may be performed with a shared memory or an efficient inter-process communication.

In conjunction with the hierarchical structure of the data processing system provided in FIG. 6 and the control instruction pipeline and the image processing pipeline shown in FIG. 12, as shown in FIG. 17, specific steps of the data processing method are as follows:
step S171, in response to a request for acquiring a target image, determine image acquiring requirement information and image processing requirement information corresponding to the target image.

In an embodiment, the request for acquiring the target image may be a request issued by an application layer to an auxiliary unit, for acquiring the target image. For example, the request for acquiring the target image may be a request sent from a user to edit an existing image (such as beautifying or adding special effects) or to generate a new target image by using an existing image through a camera application on a mobile terminal.

In an implementation, based on the hierarchical structure of the data processing system shown in FIG. 6, in the step, the request for acquiring the target image issued by the application is received through the auxiliary unit; the request is parsed through the auxiliary unit, to determine the image acquiring requirement information and the image processing requirement information corresponding to the target image.

In an embodiment, the image acquiring requirement information may include information related to a to-be-acquired image, such as an image storage directory, an image type, an image name, etc.

The image processing requirement information includes relevant requirement information for acquiring the target image by performing the image processing on the captured image, which may be basic image processing or computational photography image processing. For example, the basic image processing may include: color correction, demosaic, level noise removal, etc. The computational photography image processing may include: portrait beauty, facial tracking, a portrait style, etc.
Step S172, acquire, according to the image acquiring requirement information, image data and/or image metadata of the image data.

After the image acquiring requirement information is determined, the required image data and/or image metadata of the image data may be acquired according to the image acquiring

In an embodiment, the image metadata of the image data is used to describe data of the image data, which may include a size, a resolution, an image format, image semantic information, etc. of the image data.

In an implementation, in this step, an image acquiring instruction is generated according to the image acquiring requirement information through the auxiliary unit, and the image acquiring instruction is sent to the image supply service; the required image data and/or the image metadata of the image data are acquired according to the image acquiring instruction through the image supply service.

In an embodiment, after the required image data and/or the image metadata of the image data are acquired according to the image acquiring instruction through the image supply service, the image data and/or the image metadata are transmitted to a processing service through the image supply service.
Step S173, generate, according to the image processing requirement information, an image processing instruction by using an algorithm module in an algorithm library file.

The implementation of this step is consistent with the implementation of the above step S123, which is not repeated here.
Step S174, perform, according to the image processing instruction, the image processing on the image data to obtain the target image.

The implementation of this step is consistent with the implementation of above step S124, which is not repeated here.

The embodiment of the present application provides a hierarchical structure of a new data processing system, which provides a communication mechanism between computational photography applications or computational photography algorithm modules, and uses this communication mechanism to implement an interaction and a functional reuse between various applications or algorithm modules; implements a “plugin” management mechanism for a computational photography algorithm module, adding, deleting, and modifying of the algorithm module do not need recompilation and linking of the Framework layer and the middle layer, achieving reusing of the algorithm module, simplifying the development process, and improving the development efficiency of the algorithm module; provides an advanced functional interface of the computational photography for the computational photography application layer; implements a fault isolation mechanism, and the failure of the algorithm module will not cause a serious failure in other related processes; implements efficient data sharing between algorithm modules, no frequent copying of data between modules is needed (especially a large amount of image data), and improves the data transmission efficiency.

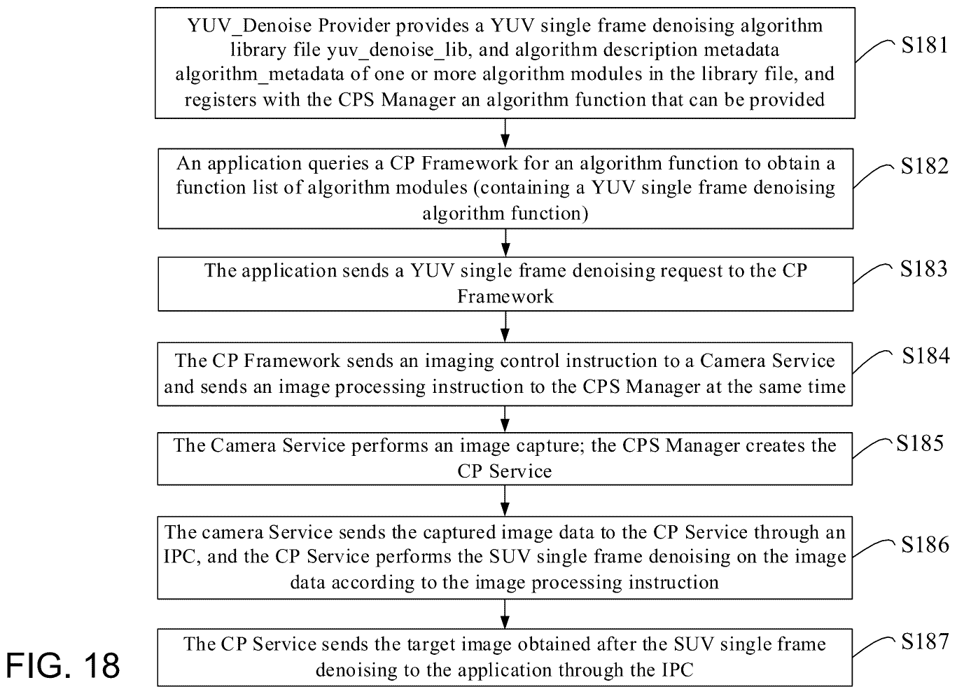

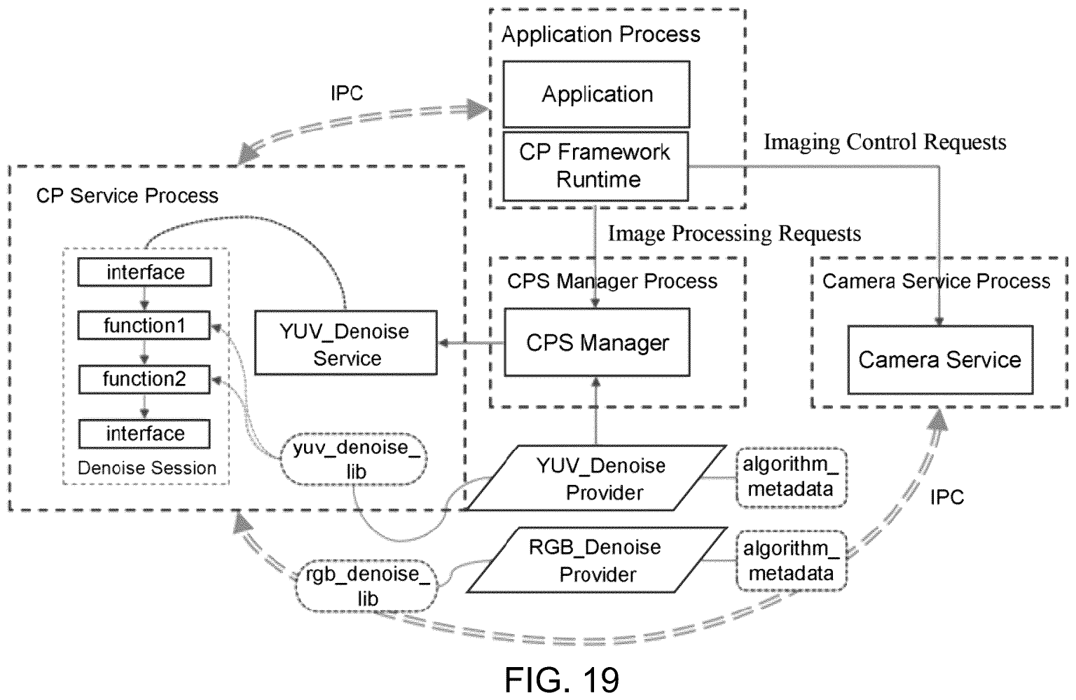

FIG. 18 is a flowchart of a method for a YUV single frame denoising provided by an eighth embodiment of the present application; FIG. 19 is a schematic diagram of a flow framework of a YUV single frame denoising provided by an eighth embodiment of the present application. On a basis of any of the above embodiments, taking the YUV single frame denoising as an example, an overall flow of a computational photography image processing method is exemplarily illustrated in the embodiment.

In conjunction with the framework shown in FIG. 19, as shown in FIG. 18, the overall process of the YUV single frame denoising is as follows:
step S181, YUV_Denoise Provider provides a YUV single frame denoising algorithm library file yuv_denoise_lib, and algorithm description metadata algorithm_metadata of one or more algorithm modules in the library file, and registers with the CPS Manager an algorithm function that can be provided.

In an embodiment, the YUV-Denoise Provider shown in FIG. 19 is a CPA provider. A preset module of the data processing system may also include algorithm library files and corresponding algorithm description metadata provided by other CPA providers.

For example, as shown in FIG. 19, the RGB_Denoise Provider provides an RGB single frame denoising algorithm library file rgd_denoise_lib, and algorithm description metadata algorithm_metadata of one or more algorithm modules in the library file, and registers with the CPS Manager the algorithm function that can be provided.
Step S182, an application queries a CP Framework for an algorithm function, to obtain a function list of algorithm modules (containing a YUV single frame denoising algorithm function).
Step S183, the application sends a YUV single frame denoising request to the CP Framework.
Step S184, the CP Framework sends an imaging control instruction to the Camera Service and sends an image processing instruction to the CPS Manager at the same time.

In an embodiment, the image processing instruction is used to perform YUV single frame denoising on the captured image data.
Step S185, the Camera Service performs an image capture; the CPS Manager creates the CP Service.

In an embodiment, the CPS Manager creates the CP Service, for performing a YUV single frame denoising processing service, and may be represented as YUV_Denoise Service. As shown in FIG. 19, the YUV_Denoise Service uses two algorithm modules function1 and function2 in the YUV single frame denoising algorithm library file yuv_denoise_lib to implement a YUV single frame denoising pipeline Denoise Session.
Step S186, the camera Service sends the captured image data to the CP Service through an IPC, and the CP Service performs the YUV single frame denoising on the image data according to the image processing instruction.
Step S187, the CP Service sends the target image obtained after the YUV single frame denoising to the application through the IPC.

As shown in FIG. 19, the CP Framework, the Camera Service, the CPS Manager and the CP Service run in different processes respectively to implement a fault isolation mechanism.

The embodiment of the present application takes the YUV single frame denoising as an example to exemplarily illustrate the overall process of the computational photographic image processing method.

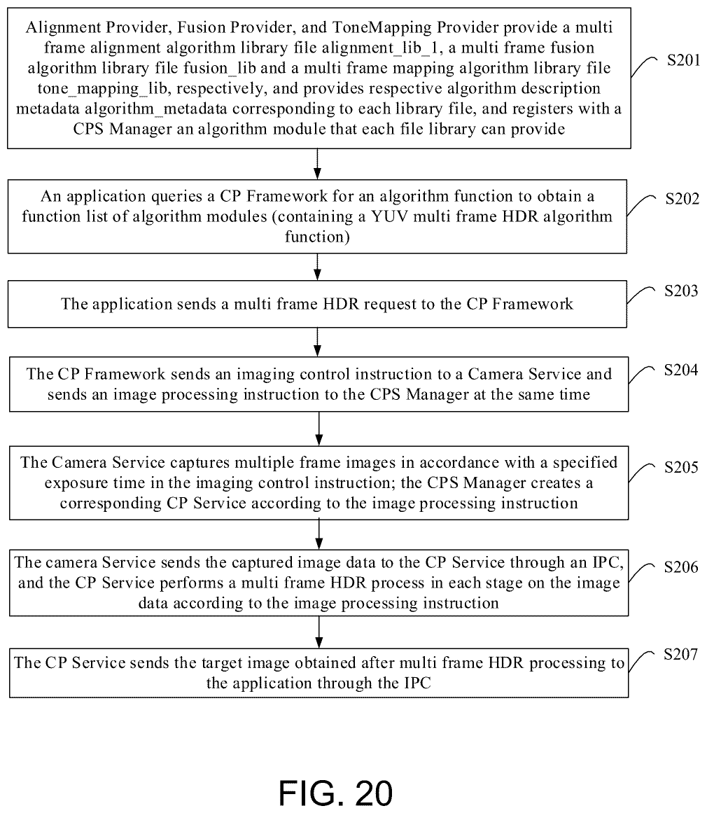

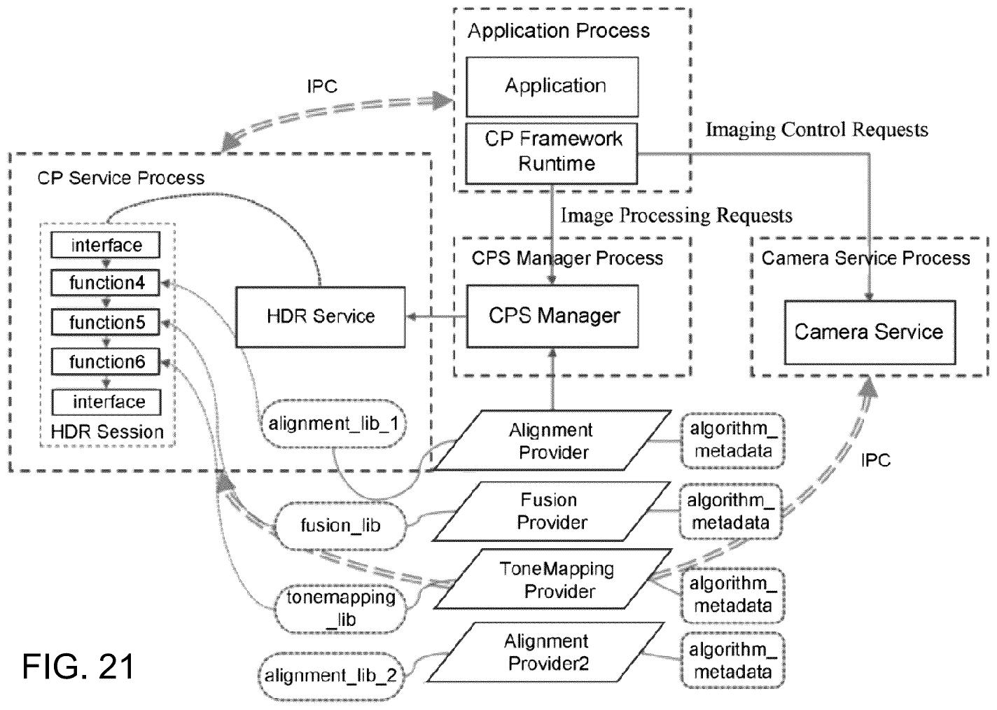

FIG. 20 is a flowchart of a method for a YUV multi frame HDR provided by a ninth embodiment of the present application; FIG. 21 is a schematic diagram of a flow framework of a YUV multi frame HDR provided by a ninth embodiment of the present application. On a basis of any of the above embodiments, taking the YUV multi frame HDR as an example, an overall flow of a computational photography image processing method is exemplarily illustrated in the embodiment.

In conjunction with the framework shown in FIG. 21, as shown in FIG. 20, the overall process of the YUV multi frame HDR is as follows:
step S201, Alignment Provider, Fusion Provider, and ToneMapping Provider provide a multi frame alignment algorithm library file alignment_lib_1, a multi frame fusion algorithm library file fusion_lib and a multi frame mapping algorithm library file tone_mapping_lib, respectively, and provides respective algorithm description metadata algorithm_metadata corresponding to each library file, and registers with a CPS Manager an algorithm module that each file library can provide.

In an embodiment, Alignment Provider, Fusion Provider and ToneMapping Provider shown in FIG. 21 are all CPA providers. A preset module of a data processing system may also include algorithm library files and corresponding algorithm description metadata provided by other CPA providers.

For example, as shown in FIG. 21, Alignment Provider2 provides a multi frame alignment algorithm library file alignment_lib_2, and algorithm description metadata algorithm_metadata corresponding to the library file, and registers with the CPS Manager the algorithm module that each file library can provide.
Step S202, an application queries a CP Framework for an algorithm function to obtain a list of algorithm functions (containing a YUV multi frame HDR algorithm function).
Step S203, the application sends a multi frame HDR request to the CP Framework.
Step S204, the CP Framework sends an imaging control instruction to a Camera Service and sends an image processing instruction to the CPS Manager at the same time.
Step S205, the Camera Service captures multiple frame images in accordance with a specified exposure time in the imaging control instruction; the CPS Manager creates a corresponding CP Service according to the image processing instruction.

In an embodiment, the CP Service created by the CPS Manager is a processing service used for multi frame HDR, which may be represented as an HDR Service. As shown in FIG. 21, the HDR Service uses algorithm modules function4, function5 and function6 in the multi frame alignment algorithm library file alignment_lib_1, the multi frame fusion algorithm library file fusion_lib and the multi frame mapping algorithm library file tone_mapping_lib respectively, to implement a multi frame HDR pipeline HDR Session.
Step S206, the Camera Service sends the captured image data to the CP Service through an IPC, and the CP Service performs a multi frame HDR process in each stage on the image data according to the image processing instruction.
Step S207, the CP Service sends a target image obtained after multi frame HDR processing to the application through the IPC.

As shown in FIG. 21, the CP Framework, the Camera Service, the CPS Manager and the CP Service run in different processes respectively to implement a fault isolation mechanism.

The embodiment of the present application takes the YUV multi frame HDR as an example to exemplarily illustrate the overall process of the computational photographic image processing method.

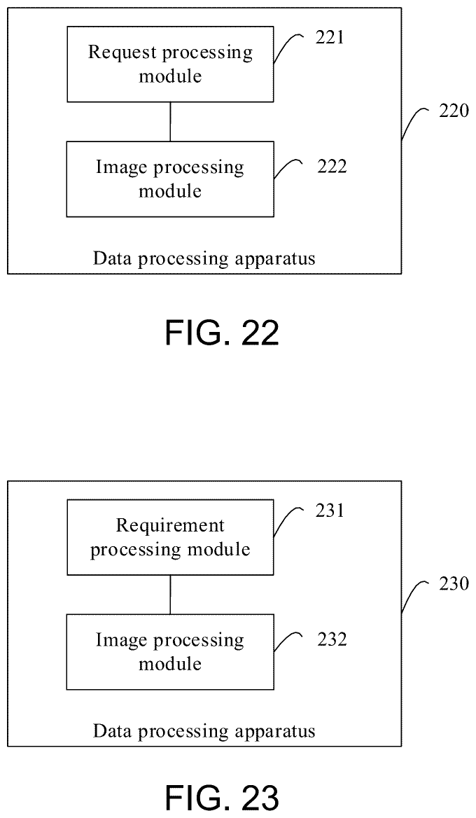

FIG. 22 is a schematic structural diagram of a data processing apparatus provided by a tenth embodiment of the present application. The data processing apparatus provided by the embodiment of the present application may execute a method flow provided in the second embodiment or the third embodiment. As shown in FIG. 22, the data processing apparatus 220 includes:
a request processing module 221, configured to execute step S10 of acquiring, through an auxiliary unit, a target image request to determine or generate an image processing instruction.
an image processing module 222, configured to execute step S11 of processing, according to the image processing instruction, image data through an image processing unit to obtain a target image.

In an embodiment, step S10 includes at least one of the following:
issuing, through the auxiliary unit, an imaging control instruction to a camera service, and issuing the image processing instruction to the image processing unit;
issuing, through the auxiliary unit, an image acquiring instruction to an image supply service, and issuing the image processing instruction to the image processing unit.

In an embodiment, step S10 includes:
parsing, through the auxiliary unit, the target image request to determine at least one of imaging control requirement information, image processing requirement information and image acquiring requirement information corresponding to the target image.

In an embodiment, step S10 includes at least one of the following:
determining or generating the imaging control instruction according to the imaging control requirement information;
determining or generating the image processing instruction according to the image processing requirement information;
determining or generating the image acquiring instruction according to the image acquiring requirement information.

In an embodiment, step S11 includes:
performing, according to the image processing instruction and/or image metadata of the image data, image processing on the image data through the image processing unit to obtain the target image.

In an embodiment, before the step S11, further included is:
acquiring, according to the imaging control instruction, the image data and/or the image metadata of the image data through a camera service;
and/or,
acquiring, according to the image acquiring instruction, the image data and/or the image metadata of the image data through an image supply service.

In an embodiment, after the acquiring, according to the imaging control instruction, the image data and/or the image metadata of the image data through the camera service, further included is:
transmitting the image data and/or the image metadata to the image processing unit; or,
transmitting the image data and/or the image metadata to a basic processing unit which then transmits processed image data and/or image metadata to the image processing unit.

In an embodiment, the image processing unit includes at least one service management module and/or at least one processing service;
the performing the image processing on the image data to obtain the target image includes:
acquiring, according to the image processing instruction, the processing service corresponding to the image processing instruction through the service management module;
performing, according to the image processing instruction and/or the image metadata, the image processing on the image data through the processing service to obtain the target image.

In an embodiment, the auxiliary unit, the service management module and the processing service perform separate independent running.

In an embodiment, the target image request is sent by an application; and/or, after the obtaining the target image, further included is: outputting the target image to enable the application to acquire the target image.

The apparatus provided in the embodiment of the present application may be specifically used to execute the method flow provided in the above second embodiment or third embodiment, and the specific function and effect are not repeated here.

FIG. 23 is a schematic structural diagram of a data processing apparatus provided by an eleventh embodiment of the present application. The data processing apparatus provided by the embodiment of the present application may execute a method flow provided in any of the fourth embodiment to the ninth embodiment. As shown in FIG. 23, the data processing apparatus 230 includes:
a requirement processing module 231, configured to execute step S20 of determining or generating, according to a preset module and image processing requirement information, an image processing instruction.
an image processing module 232, configured to execute step S21 of performing, according to the image processing instruction, image processing on image data to obtain a target image.

In an embodiment, before step the S20, further included are:
determining or generating, in response to a request for acquiring the target image, at least one of an imaging control instruction, an image processing instruction and an image acquiring instruction corresponding to the target image;
acquiring, according to the imaging control instruction and/or the image acquiring instruction, the image data and/or image metadata of the image data.

In an embodiment, the determining or the generating, in response to the request for acquiring the target image, the at least one of the imaging control instruction, the image processing instruction and the image acquiring instruction corresponding to the target image includes:
acquiring, through an auxiliary unit, the request for the target image;
parsing, through the auxiliary unit, the request to determine at least one of imaging control requirement information, image processing requirement information, and image acquiring requirement information;
if the imaging control requirement information is obtained through the parsing, determining or generating the imaging control instruction according to the imaging control requirement information;
if the image processing requirement information is obtained through the parsing, determining or generating the image processing instruction according to image processing requirement information;
if the image acquiring requirement information is obtained through the parsing, determining or generating the image acquiring instruction according to the image acquiring requirement information.

In an embodiment, the acquiring, according to the imaging control instruction and/or the image acquiring instruction, the image data and/or the image metadata of the image data including:
sending, through the auxiliary unit, the imaging control instruction to a camera service, and acquiring, according to the imaging control instruction, captured image data and/or image metadata of the image data through the camera service;
and/or, sending, through the auxiliary unit, the image acquiring instruction to an image supply service, and acquiring, according to the image acquiring instruction, the image data and/or the image metadata of the image data through the image supply service.

In an embodiment, the step S20 includes:
using, according to the image processing requirement information, the preset module through the auxiliary unit to determine or generate the image processing instruction. In an embodiment, the step S20 includes:
determining, according to the image processing requirement information and algorithm description metadata of an algorithm module in an algorithm library file provided by the preset module, at least one algorithm module that matches the image processing requirement information;
assembling, according to the image processing requirement information, the at least one algorithm module to determine or generate the image processing instruction.

In an embodiment, the determining, according to the image processing requirement information and the algorithm description metadata of the algorithm module in the algorithm library file provided by the preset module, the at least one algorithm module that matches the image processing requirement information includes:
according to the image processing requirement information, if it is determined that the at least one algorithm module is missing from the preset module, acquiring, from a server, the missed at least one algorithm module.

In an embodiment, the step S20 further includes:
sending, through the auxiliary unit, the image processing instruction to a service management module.

In an embodiment, the step S21 includes:
acquiring, through the service management module, a processing service corresponding to the image processing instruction;
performing, according to the image processing instruction and/or the image metadata, the image processing on the image data through the processing service to obtain the target image.

In an embodiment, the acquiring, through the service management module, the processing service corresponding to the image processing instruction includes at least one of the following:
through the service management module, according to the image processing instruction, if it is determined that there is a processing service that matches the image processing instruction and is in an idle state, using the processing service that matches the image processing instruction and is in the idle state as a processing service corresponding to the image processing instruction;
through the service management module, according to the image processing instruction, if it is determined that there is a processing service that matches the image processing instruction and the processing service that matches the image processing instruction is in an occupied state, creating the processing service corresponding to the image processing instruction, or, until the processing service that matches the image processing instruction enters an idle state, using the processing service that matches the image processing instruction and is in the idle state as the processing service corresponding to the image processing instruction;
through the service management module, according to the image processing instruction, if it is determined that there is no processing service that matches the image processing instruction, creating, according to the image processing instruction, a processing service corresponding to the image processing instruction.

In an embodiment, after the using the processing service that matches the image processing instruction and is in the idle state as the service corresponding to the image processing instruction, further included is:
if the processing service corresponding to the image processing instruction is not stored in a memory, loading the processing service corresponding to the image processing instruction into the memory, and starting the processing service corresponding to the image processing instruction.

In an embodiment, further included is at least one of the following:
after the acquiring, according to the imaging control instruction, the captured image data and/or the image metadata of the image data through the camera service, further included is: transmitting, through the camera service, the image data and/or the image metadata to the processing service;
after the acquiring, according to the image acquiring instruction, the image data and/or the image metadata of the image data through the image supply service, further included is: transmitting, through the image supply service, the image data and/or the image metadata to the processing service.

In an embodiment, further included is at least one of the following:
the performing, according to the image processing instruction and/or the image metadata, the image processing on the image data through the processing service to obtain the target image includes: executing, according to the image processing instruction and/or the image metadata, a processing pipeline corresponding to the image processing instruction through the processing service to implement the image processing on the image data to obtain the target image; after the performing, according to the image processing instruction and/or the image metadata, the image processing on the image data through the processing service to obtain the target image, further included is: feeding back, through the processing service, the target image to the auxiliary unit, outputting, through the auxiliary unit, the target image.

In an embodiment, after the feeding back, through the processing service, the target image to the auxiliary unit, further included is:
pausing and saving, or destroying, according to the image processing instruction, the processing service through the service management module.

In an embodiment, included at least one of the following is:
the transmitting, through the camera service, the image data and/or the image metadata to the processing service includes: storing, through the camera service, the image data and/or the image metadata in a shared memory, and acquiring, through the processing service, the image data and/or the image metadata from the shared memory;
the transmitting, through the image supply service, the image data and/or the image metadata to the processing service includes: storing, through the image supply service, the image data and/or the image metadata in the shared memory, and acquiring, through the processing service, the image data and/or the image metadata from the shared memory.

In an embodiment, the feeding back, through the processing service, the target image to the auxiliary unit includes:
storing, through the processing service, the target image in a shared memory;
acquiring, from the shared memory, the target image through the auxiliary unit.

In an embodiment, the auxiliary unit acquires the request through an application programming interface, the application programming interface is used to implement a corresponding computational photography image processing function by calling at least one algorithm module in an algorithm library file.

In an embodiment, the preset module is provided by a data processing system, and/or, the preset module includes at least one algorithm library file and algorithm description metadata corresponding to the at least one algorithm library file.

In an embodiment, the apparatus further includes at least one of the following:
in response to an algorithm function query request, acquiring and displaying the at least one algorithm library file, and/or at least one set of algorithm description metadata corresponding to the algorithm library file;
in response to an algorithm library file new adding request, adding a newly added algorithm library file and algorithm description metadata corresponding to the algorithm library file to an algorithm library;
in response to a deleting request for any algorithm library file, deleting, from the algorithm library, the algorithm library file and algorithm description metadata corresponding to the algorithm library file;
in response to a modification operation on any algorithm library file, recompiling a modified algorithm library file;
in response to a modification request for algorithm description metadata of any algorithm module in any algorithm library file, updating the algorithm description metadata of the algorithm module in the algorithm library.

In an embodiment, the performing, according to the image processing instruction, the image processing on the image data to obtain the target image further includes:
loading, according to the image processing instruction, the algorithm library file into a memory.

The apparatus provided in the embodiment of the present application may be specifically used to execute the method flow provided in the above fourth embodiment to ninth embodiment, and the specific function and effect are not repeated here.

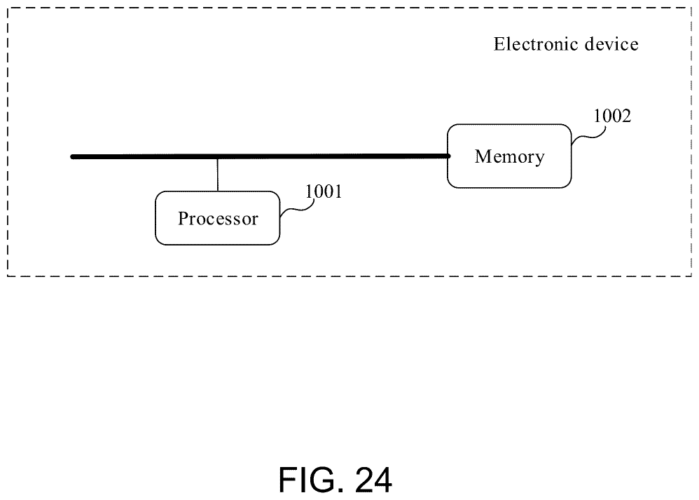

FIG. 24 is a schematic structural diagram of an electronic device provided by a twelfth embodiment of the present application. As shown in FIG. 24, the electronic device includes a processor 1001 and a memory 1002. The memory 1002 stores computer execution instructions and related data.

In an embodiment, the relevant data includes but is not limited to: image data, various metadata, and other data required to realize the claims.

The processor 1001 executes the computer execution instructions stored in the memory 1002, causing the processor 1001 to execute the method flow provided in any of the above method embodiments, and a specific function is not repeated here.

The embodiment of the present application provides a hierarchical structure of a new data processing system, which provides a communication mechanism between computational photography applications or computational photography algorithm modules, and uses this communication mechanism to implement an interaction and a functional reuse between various applications or algorithm modules; implements a “plugin” management mechanism for a computational photography algorithm module, adding, deleting and modifying of the algorithm module do not need recompilation and linking of the Framework layer and the middle layer, achieving reusing of the algorithm module, simplifying the development process, and improving the development efficiency of the algorithm module; provides an advanced functional interface of the computational photography for the computational photography application layer; achieves a fault isolation mechanism, and the failure of the algorithm module will not cause a serious failure in other related processes; achieves efficient data sharing between algorithm modules, no frequent copying of data between modules is needed (especially a large amount of image data), and improves the data transmission efficiency.

An embodiment of the present application further provides an intelligent terminal, which includes a memory and a processor. The memory stores data processing programs, and when the data processing programs are executed by the processor, the steps of the data processing method in any of the above embodiments are implemented.

An embodiment of the present application further provides a computer readable storage medium, having data processing programs stored thereon, and when the data processing programs are executed by a processor, the steps of the data processing method in any of the above embodiments are implemented.

In the embodiments of the intelligent terminal and the computer readable storage medium provided in the present application, all technical features of any of the above data processing method embodiments may be contained, the expansion and explanation content of the specification is basically the same as that of the various embodiments of the above methods, and which will not be repeated here.

An embodiment of the present application further provides a computer program product, the computer program product includes computer program codes, and when the computer program codes are running on a computer, enable the computer to execute the methods described in the above various possible implementations.

An embodiment of the present application further provides a chip, including a memory and a processor, the memory is used to store computer programs, and the processor is configured to call and run the computer programs from the memory, enable the device installed with the chip to execute the methods described in the above various possible implementations.

It can be understood that the above scenario is only used as an example and does not constitute a restriction on the application scenarios of the technical solution provided in the embodiment of the present application, the technical solution of the present application may also be applied to other scenarios. For example, those ordinarily skilled in the art know that with the evolution of system architecture and the emergence of new business scenarios, the technical solution provided in the embodiments of the present application is also applicable to similar technical problems.

The serial numbers of above embodiments of the present application are only for description and do not represent the advantages or disadvantages of the embodiments.

The steps of the methods in the embodiment of the present application may be sequentially adjusted, merged, and deleted in order according to actual requirements.

The units in the device in the embodiment of the present application may be merged, divided, and deleted according to actual requirements.

In the present application, the same or similar term concepts, technical solutions, and/or application scenario descriptions, detailed descriptions are generally described only at the first occurrence, when reoccurring later, they are generally not repeated for the sake of brevity. When understanding the technical solution and other contents of the present application, etc., for the same or similar terminology concepts, technical solutions, and/or application scenario descriptions etc., which are not described in detail later may refer to its previous detailed description.

In the present application, the description of each embodiment has its own emphasis. For parts that are not described in detail or recorded in a certain embodiment, please refer to the relevant descriptions of other embodiments.

The various technical features of the technical solution in the present application may be combined randomly. To make the description concise, all possible combinations of the various technical features in the above embodiments have not been described. However, as long as there is no contradiction in the combination of these technical features, they should all be considered to fall within the scope of the recordings in the present application.

Through the description of the above implementations, those skilled in the art can clearly understand that the above implementations may be implemented through software plus a necessary general hardware platform, of course, also may be implemented through hardware, however, in many cases, the former is the better implementation. Based on such understanding, the technical solution of the present application in essence, or a part thereof contributing to the existing technology, may be embodied in a form of a software product. The computer software product is stored in a storage medium (e.g., a ROM (Read Only Memory)/RAM (Random Access Memory), a magnetic disk, an optical disk), including several instructions to cause a terminal device (which may be a mobile phone, a computer, a server, a controlled terminal, or a network device, etc.) to execute the method in each embodiment of the present application.

The above embodiments may be implemented wholly or in part by software, hardware, firmware, or any combination thereof. When the above embodiments are implemented using software, all or part of them may be implemented in the form of computer program products. The computer program products include one or more computer instructions. When loading and executing computer instructions on a computer, all or part of the processes or functions according to the embodiments of the present application are generated. The computer may be a general-purpose computer, a special-purpose computer, a computer network, or other programmable apparatuses. The computer instructions may be stored in a computer readable storage medium, or transmitted from one computer readable storage medium to another computer readable storage medium. For example, the computer instructions may be transmitted from one website site, computer, server, or data center via wired (such as a coaxial cable, a fiber optic, a digital user line) or wireless (such as an infrared, a wireless, a microwave, etc.) to another website site, computer, or data center server or data center. The computer readable storage medium may be any available medium that the computer can access, or a data storage device that includes one or more available media integrations such as a server or a data center. The available medium may be a magnetic medium (for example, a floppy disk, a storage disk, a magnetic tape), an optical medium (for example, DVDs), or a semiconductor medium (for example, a solid state disk (SSD)), etc.

The above descriptions are only preferred embodiments of the present application and are not intended to limit the patent scope thereof. Equivalent structures or equivalent flow transformations made using the description and drawings of the present application, or direct or indirect applications in other related technical fields, are all equally included in the patent protection scope of the present application.

What is claimed is:

1. A data processing method, comprising the following steps:
step S10: acquiring, through an auxiliary unit, a target image request to determine or generate an image processing instruction;
step S11: processing, according to the image processing instruction, image data through an image processing unit to obtain a target image.

2. The method according to claim 1, wherein the step S10 comprises at least one of the following:
issuing, through the auxiliary unit, an imaging control instruction to a camera service, and issuing the image processing instruction to the image processing unit;
issuing, through the auxiliary unit, an image acquiring instruction to an image supply service, and issuing the image processing instruction to the image processing unit.

3. The method according to claim 2, wherein the step S10 comprises:
parsing, through the auxiliary unit, the target image request to determine at least one of imaging control requirement information, image processing requirement information and image acquiring requirement information corresponding to the target image.

4. The method according to claim 3, wherein the step S10 comprises at least one of the following:
determining or generating the imaging control instruction according to the imaging control requirement information;
determining or generating the image processing instruction according to the image processing requirement information;
determining or generating the image acquiring instruction according to the image acquiring requirement information.

5. The method according to claim 1, wherein the step S11 comprises:
performing, according to the image processing instruction and/or image metadata of the image data, image processing on the image data through the image processing unit to obtain the target image.

6. The method according to claim 5, before the step S11, further comprising:
acquiring, according to the imaging control instruction, the image data and/or the image metadata of the image data through a camera service;
and/or,
acquiring, according to the image acquiring instruction, the image data and/or the image metadata of the image data through an image supply service;
after the acquiring, according to the imaging control instruction, the image data and/or the image metadata of the image data, further comprising:
transmitting the image data and/or the image metadata to the image processing unit; or,
transmitting the image data and/or the image metadata to a basic processing unit which then transmits processed image data and/or image metadata to the image processing unit.

7. A data processing method, comprising the following steps:
step S20: determining or generating, according to a preset module and image processing requirement information, an image processing instruction;
step S21: performing, according to the image processing instruction, image processing on image data to obtain a target image.

8. The method according to claim 7, before the step S20, further comprising:
determining or generating, in response to a request for acquiring the target image, at least one of an imaging control instruction, an image processing instruction and an image acquiring instruction corresponding to the target image;
acquiring, according to the imaging control instruction and/or the image acquiring instruction, the image data and/or image metadata of the image data.

9. The method according to claim 8, wherein the determining or the generating, in response to the request for acquiring the target image, the at least one of the imaging control instruction, the image processing instruction and the image acquiring instruction corresponding to the target image comprises:
acquiring, through an auxiliary unit, the request for the target image;
parsing, through the auxiliary unit, the request to determine at least one of imaging control requirement information, image processing requirement information and image acquiring requirement information;
if the imaging control requirement information is obtained through the parsing, determining or generating the imaging control instruction according to the imaging control requirement information;
if the image processing requirement information is obtained through the parsing, determining or generating the image processing instruction according to image processing requirement information;
if the image acquiring requirement information is obtained through the parsing, determining or generating the image acquiring instruction according to the image acquiring requirement information;
wherein the acquiring, according to the imaging control instruction and/or the image acquiring instruction, the image data and/or the image metadata of the image data comprises:
sending, through the auxiliary unit, the imaging control instruction to a camera service, and acquiring, according to the imaging control instruction, captured image data and/or image metadata of the image data through the camera service;
and/or,
sending, through the auxiliary unit, the image acquiring instruction to an image supply service, and acquiring, according to the image acquiring instruction, the image data and/or the image metadata of the image data through the image supply service.

10. The method according to claim 9, wherein the step S20 comprises:
using, according to the image processing requirement information, the preset module through the auxiliary unit to determine or generate the image processing instruction.

11. The method according to claim 10, wherein the step S20 further comprises:
sending, through the auxiliary unit, the image processing instruction to a service management module;
wherein the step S21 comprises:
acquiring, through the service management module, a processing service corresponding to the image processing instruction;
performing, according to the image processing instruction and/or the image metadata, the image processing on the image data through the processing service to obtain the target image.

12. The method according to claim 11, wherein the acquiring, through the service management module, the processing service corresponding to the image processing instruction comprises at least one of the following:
through the service management module, according to the image processing instruction, if it is determined that there is a processing service that matches the image processing instruction and is in an idle state, using the processing service that matches the image processing instruction and is in the idle state as a processing service corresponding to the image processing instruction;
through the service management module, according to the image processing instruction, if it is determined that there is a processing service that matches the image processing instruction and the processing service that matches the image processing instruction is in an occupied state, creating the processing service corresponding to the image processing instruction, or, until the processing service that matches the image processing instruction enters an idle state, using the processing service that matches the image processing instruction and is in the idle state as the processing service corresponding to the image processing instruction;
through the service management module, according to the image processing instruction, if it is determined that there is no processing service that matches the image processing instruction, creating, according to the image processing instruction, a processing service corresponding to the image processing instruction;
after the using the processing service that matches the image processing instruction and is in the idle state as the processing service corresponding to the image processing instruction, further comprising:
if the processing service corresponding to the image processing instruction is not stored in a memory, loading the processing service corresponding to the image processing instruction into the memory, and starting the processing service corresponding to the image processing instruction.

13. The method according to claim 11, further comprising at least one of the following:
after the acquiring, according to the imaging control instruction, the captured image data and/or the image metadata of the image data through the camera service, the method further comprises: transmitting, through the camera service, the image data and/or the image metadata to the processing service;
after the acquiring, according to the image acquiring instruction, the image data and/or the image metadata of the image data through the image supply service, the method further comprises: transmitting, through the image supply service, the image data and/or the image metadata to the processing service.

14. The method according to claim 11, further comprising at least one of the following:
the performing, according to the image processing instruction and/or the image metadata, the image processing on the image data through the processing service to obtain the target image comprises: executing, according to the image processing instruction and/or the image metadata, a processing pipeline corresponding to the image processing instruction through the processing service to implement the image processing on the image data to obtain the target image; after the performing, according to the image processing instruction and/or the image metadata, the image processing on the image data through the processing service to obtain the target image, the method further comprises: feeding back, through the processing service, the target image to the auxiliary unit, outputting, through the auxiliary unit, the target image.

15. The method according to claim 14, after the feeding back, through the processing service, the target image to the auxiliary unit, further comprising:
pausing and saving, or destroying, according to the image processing instruction, the processing service through the service management module.

16. A data processing system, comprising: an auxiliary unit and an image processing unit;
wherein the image processing unit comprises a first processing module and a second processing module;
the first processing module is configured to control, according to an image processing instruction, the second processing module;
the second processing module is configured to perform, according to the image processing instruction, image processing on image data to obtain a target image.

17. The data processing system according to claim 16, further comprising: an inter-process communication driver, wherein each of the auxiliary unit, the first processing module and the second processing module contains an inter-process communication interface,
the inter-process communication interface is used between corresponding processes of any two of the auxiliary unit, the first processing module and the second processing module, and the inter-process communication driver is utilized to implement an inter-process communication;
wherein the auxiliary unit further comprises a program library for implementing an application programming interface and the inter-process communication interface.

18. The data processing system according to claim 16, wherein the auxiliary unit is configured to:
parse a request for acquiring the target image issued by an application, and determine at least one of imaging control requirement information, image processing requirement information and image acquiring requirement information corresponding to the target image;
determine or generate the image processing instruction according to the image processing requirement information, and issue the image processing instruction to the image processing unit;
wherein the auxiliary unit is specifically configured to:
determine, according to the image processing requirement information and algorithm description metadata of an algorithm module, at least one algorithm module that matches the image processing requirement information;
assemble, according to the image processing requirement information, the at least one algorithm module to determine or generate the image processing instruction.

19. The data processing system according to claim 18, wherein the auxiliary unit is further configured to:
determine or generate an imaging control instruction according to the imaging control requirement information, and issue the imaging control instruction to a camera service;
and/or,
determine or generate an image acquiring instruction according to the image acquiring requirement information, and issue the image acquiring instruction to an image supply service.

20. The data processing system according to claim 16, wherein the first processing module is configured to at least one of the following:
according to the image processing instruction, if it is determined that there is a second processing module that matches the image processing instruction and is in an idle state, use the second processing module that matches the image processing instruction and is in the idle state as a second processing module corresponding to the image processing instruction;
according to the image processing instruction, if it is determined that there is a second processing module that matches the image processing instruction and the second processing module that matches the image processing instruction is in an occupied state, create a second processing module corresponding to the image processing instruction, or until the second processing module that matches the image processing instruction enters an idle state, use the second processing module that matches the image processing instruction and is in the idle state as a second processing module corresponding to the image processing instruction;
according to the image processing instruction, if it is determined that there is no second processing module that matches the image processing instruction, create, according to the image processing instruction, a second processing module corresponding to the image processing instruction;
after using the second processing module that matches the image processing instruction and is in the idle state as the second processing module corresponding to the image processing instruction, if the second processing module corresponding to the image processing instruction is not stored in a memory, load the second processing module corresponding to the image processing instruction into the memory and start the second processing module corresponding to the image processing instruction.
